(19) United States
(12) Patent Application Publication
(10) Pub. No.: US 2011/0315396 A1
(43) Pub. Date: Dec. 29, 2011

(54) METHOD AND APPARATUS FOR CONTROLLING VALVES OF A SUBSEA OIL SPILL CONTAINMENT ASSEMBLY

(75) Inventor: Scott Wolinsky, Sewell, NJ (US)

(73) Assignee: Subsea IP Holdings LLC, Sewell, NJ (US)

(21) Appl. No.: 12/966,426

(22) Filed: Dec. 13, 2010

Related U.S. Application Data
(63) Continuation of application No. 12/860,001, filed on Aug. 20, 2010.
Application No. 12/860,001 is a continuation-in-part of application No. 12/822,324, filed on Jun. 24, 2010.

(51) Int. Cl. E21B 34/04; G05D 7/00

(52) U.S. Cl. 166/363; 700/282

(57) ABSTRACT

A method and apparatus are described for controlling valves of a subsea oil spill containment assembly. In one embodiment, a control unit is configured to control at least one reinforcement material input valve of the subsea oil spill containment assembly. In another embodiment, the control unit is configured to control at least one flooding valve of the subsea oil spill containment assembly. In yet another embodiment, the control unit is configured to control a large diameter high pressure valve of the subsea oil spill containment assembly. The control unit may be configured to control each reinforcement material input valve, flooding valve and large diameter high pressure valve of the subsea oil spill containment assembly, either wirelessly or via a wired interface, such that each valve may be maintained in an open position, a partially open position or a closed position, as desired.

### CROSS REFERENCE TO RELATED APPLICATIONS

This application is a continuation of U.S. patent application Ser. No. 12/860,001, filed Aug. 20, 2010, which is a continuation-in-part of U.S. patent application Ser. No. 12/822,324, filed Jun. 24, 2010, which are incorporated by reference as if fully set forth herein.

### TECHNICAL FIELD

This application generally relates to a method and apparatus for containing an oil and/or gas spill originating from the bottom of an ocean.

### BACKGROUND

An offshore platform, often referred to as an oil platform or an oil rig, is a large structure used in offshore drilling to house workers and machinery needed to drill wells in the ocean bed, extract oil and/or natural gas, process the produced fluids, and ship or pipe them to shore. Depending on the circumstances, the platform may be fixed to the ocean floor, may consist of an artificial island, or may float.

Remote subsea wells may also be connected to a platform by flow lines and by umbilical connections. These subsea solutions may consist of single wells or of a manifold center for multiple wells.

FIG. 1 shows a deep sea drilling rig 100 on an ocean surface 105 that processes oil and/or gas 110 obtained from below an ocean floor 115 via a blowout preventer (BOP) stack 120 and a riser assembly 125.

FIG. 2 illustrates a deep sea drilling rig 100′ after exploding due to a defective BOP stack 120′, causing an oil and/or gas spill 210 that pollutes the ocean and needs to be contained. The explosion may further cause the riser assembly 125 to break into portions 125′ and 125″.

The Deepwater Horizon oil spill, also called the BP oil spill, the Gulf of Mexico oil spill or the Macondo blowout, was a massive oil spill in the Gulf of Mexico, and is considered the largest offshore spill to ever occur in U.S. history. The spill stemmed from a sea floor oil gusher that started with an oil well blowout on Apr. 20, 2010. The blowout caused a catastrophic explosion on the Deepwater Horizon offshore oil drilling platform that was situated about 40 miles (64 km) southeast of the Louisiana coast in the Macondo Prospect oil field. The explosion killed 11 platform workers and injured 17 others. Another 98 people survived without serious physical injury.

Although numerous crews worked to block off bays and estuaries, using anchored barriers, floating containment booms, and sand-filled barricades along shorelines, the oil spill resulted in an environmental disaster characterized by petroleum toxicity and oxygen depletion, thus damaging the Gulf of Mexico fishing industry, the Gulf Coast tourism industry, and the habitat of hundreds of bird species, fish and other wildlife. A variety of ongoing efforts, both short and long term, were made to contain the leak and stop spilling additional oil into the Gulf, without immediate success.

After the Deepwater Horizon drilling rig explosion on Apr. 20, 2010, a BOP should have activated itself automatically to avoid an oil spill in the Gulf of Mexico. The oil spill originated from a deepwater oil well 5,000 feet (1,500 m) below the ocean surface. A BOP is a large valve that has a variety of ways to choke off the flow of oil from a gushing oil well. If underground pressure forces oil or gas into the wellbore, operators can close the valve remotely (usually via hydraulic actuators) to forestall a blowout, and regain control of the wellbore. Once this is accomplished, often the drilling mud density within the hole can be increased until adequate fluid pressure is placed on the influx zone, and the BOP can be opened for operations to resume. The purpose of BOPs is to end oil gushers, which are dangerous and costly.

Underwater robots were sent to manually activate the Deepwater Horizon's BOP without success. BP representatives suggested that the BOP may have suffered a hydraulic leak. However, X-ray imaging of the BOP showed that the BOP's internal valves were partially closed and were restricting the flow of oil. Whether the valves closed automatically during the explosion or were shut manually by remotely operated vehicle work is unknown.

BOPs come in a variety of styles, sizes and pressure ratings, and usually several individual units compose a BOP stack. The BOP stack used for the Deepwater Horizon is quite large, consisting of a five-story-tall, 300-ton series of oil well control devices.

The amount of oil that was discharged after the Deepwater Horizon drilling rig explosion is estimated to have ranged from 12,000 to 100,000 barrels (500,000 to 4,200,000 gallons) per day. The volume of oil flowing from the blown-out well was estimated at 12,000 to 19,000 barrels (500,000 to 800,000 gallons) per day, which had amounted to between 440,000 and 700,000 barrels (18,000,000 and 29,000,000 gallons). In any case, an oil slick resulted that covered a surface area of over 2,500 square miles (6,500 km²). Scientists had also discovered immense underwater plumes of oil not visible from the surface.

Various solutions have been attempted to control or stop an undersea oil and/or gas spill. One solution is to use a heavy (e.g., over 100 tons) container dome over an oil well leak and pipe the oil to a storage vessel floating on the ocean surface. However, this solution has failed in the past due to hydrate crystals, which form when gas combines with cold water, blocking up a steel canopy at the top of the dome. Thus, excess buoyancy of the crystals clogged the opening at the top of the dome where the riser was to be connected.

Another solution is to attempt to shut down the well completely using a technique called “top kill”. This solution involves pumping heavy drilling fluids into the defective BOP, causing the flow of oil from the well to be restricted, which then may be sealed permanently with cement and/or mud. However, this solution has not been successful in the past.

It would be desirable to have a method and apparatus readily available to successfully contain oil and/or gas spewing from a defective BOP stack, until an alternate means is made available to permanently cap or bypass the oil and/or gas spill, or to repair/replace the defective BOP stack.

### SUMMARY OF EMBODIMENTS

A method and apparatus are described for controlling valves of a subsea oil spill containment assembly. In one embodiment, a control unit is configured to control at least one reinforcement material input valve of the subsea oil spill containment assembly. In another embodiment, the control unit is configured to control at least one flooding valve of the subsea oil spill containment assembly. In yet another embodiment, the control unit is configured to control a large diameter high pressure valve of the subsea oil spill containment assembly. The control unit may be configured to control each reinforcement material input valve, flooding valve and large diameter high pressure valve of the subsea oil spill containment assembly, either wirelessly or via a wired interface, such that each valve may be maintained in an open position, a partially open position or a closed position, as desired.

The reinforcement material input valve may be used to fill a reinforcement cavity of the subsea oil spill containment assembly with reinforcement material including at least one of cement and mud. The reinforcement cavity may reside between an inner wall and an outer wall of the containment assembly.

The valves may be remotely controlled either wirelessly or via a wired or hydraulic connection from a vessel floating on an ocean surface.

The reinforcement material input valve may be used to fill a hollow cavity of the subsea oil spill containment assembly with reinforcement material including at least one of cement and mud. The hollow cavity may surround a large diameter high pressure valve.

The valve may be a flooding valve used to fill a reinforcement cavity of the subsea oil spill containment assembly with water from an ocean to submerge the containment assembly below the ocean surface. The reinforcement cavity may reside between an inner wall and an outer wall of the containment assembly.

The valve may be a flooding valve used to fill a hollow cavity of the subsea oil spill containment assembly with water from an ocean to submerge the containment assembly below the ocean surface. The hollow cavity may surround a large diameter high pressure valve.

The valve may be a large diameter high pressure valve used to control the flow of at least one of oil or gas spewing from a defective blowout preventer (BOP) stack. At least one heating element may be activated to heat up the large diameter high pressure valve. The heating element may be remotely controlled either wirelessly or via a wired or hydraulic connection from a vessel floating on an ocean surface.

The large diameter high pressure valve may be automatically opened when a pressure within the subsea oil spill containment assembly reaches or exceeds a predetermined threshold.

### BRIEF DESCRIPTION OF THE DRAWINGS

A more detailed understanding may be had from the following description, given by way of example in conjunction with the accompanying drawings wherein:

FIG. 1 shows a simplified diagram of a deep sea drilling rig on a surface of an ocean that processes oil and/or gas received from a BOP stack located on a floor of the ocean;

FIG. 2 shows a deep sea drilling rig after exploding due to a defective BOP stack, and causing an oil and/or gas spill that needs to be contained;

FIG. 3A shows a top view of a cylindrical BOPstopper containment assembly that is configured in accordance with a first embodiment of the present invention;

FIG. 3B shows a side view of the cylindrical BOPstopper containment assembly of FIG. 3A;

FIG. 3C is a block diagram of a communications and control unit (CCU) used with the cylindrical BOPstopper containment assembly of FIGS. 3A and 3B;

FIG. 3D shows a top view of the defective BOP stack and an outline of the outer wall of a cylindrical BOPstopper containment assembly circumventing the defective BOP stack on a portion of the ocean floor;

FIG. 3E shows a cross-sectional view of the cylindrical BOPstopper containment assembly of FIGS. 3A and 3B;

FIG. 3F shows a cross-sectional view of a reinforcement cavity in a hollow wall of the cylindrical BOPstopper containment assembly of FIG. 3E while being filled with reinforcement material (e.g., cement and/or mud);

FIG. 3G shows a top view of a square cuboid BOPstopper containment assembly that is configured in accordance with the first embodiment of the present invention;

FIG. 3H shows a side view of the square cuboid BOPstopper containment assembly of FIG. 3G;

FIG. 31 is a block diagram of a CCU used with the square cuboid BOPstopper containment assembly of FIGS. 3G and 3H;

FIG. 4A shows a top view of a cylindrical BOPstopper valve assembly that is configured in accordance with a first embodiment of the present invention;

FIG. 4B shows a side view of the cylindrical BOPstopper valve assembly of FIG. 4A;

FIG. 4C is a block diagram of a CCU used with the cylindrical BOPstopper valve assembly of FIGS. 4A and 4B;

FIG. 4D shows a top view of a square cuboid BOPstopper valve assembly that is configured in accordance with the first embodiment of the present invention;

FIG. 4E shows a side view of the square cuboid BOPstopper valve assembly of FIG. 4D;

FIG. 4F is a block diagram of a CCU used with the square cuboid BOPstopper valve assembly of FIGS. 4D and 4E;

FIG. 5 shows a cross-sectional view of the cylindrical BOPstopper valve assembly positioned on top of the reinforced cylindrical BOPstopper containment assembly while a large diameter high pressure valve of the cylindrical BOPstopper valve assembly is maintained in an open position;

FIGS. 6 shows a cross-sectional view of a hollow cavity of the cylindrical BOPstopper valve assembly while being filled with reinforcement material (e.g., cement and/or mud);

FIG. 7 shows a cross-sectional view of the reinforced cylindrical BOPstopper valve assembly positioned on top of the reinforced cylindrical BOPstopper containment assembly while the large diameter high pressure valve of the cylindrical BOPstopper valve assembly is maintained in an closed position;

FIGS. 8A and 8B show a side view of the reinforced cylindrical BOPstopper valve assembly positioned on top of the reinforced cylindrical BOPstopper containment assembly;

FIGS. 9A and 9B show a side view of a reinforced square cuboid BOPstopper valve assembly positioned on top of the reinforced square cuboid BOPstopper containment assembly;

FIGS. 10A and 10B, taken together, are a flow diagram of a procedure for containing oil and/or gas spewing from a defective BOP stack using a BOPstopper containment assembly and a BOPstopper valve assembly in accordance with the first embodiment of the present invention;

FIG. 11A shows a primary containment assembly including a self-fastening mechanism having fastening devices and sealing devices in accordance with a second embodiment of the present invention;

FIG. 11B shows a top view of the primary containment assembly of FIG. 11A;

FIG. 11C shows a bottom view of the primary containment assembly of FIG. 11A including activated fastening devices and sealing devices;

FIG. 11D shows a side view of the primary containment assembly of FIG. 11A circumventing the defective BOP stack and fastened to the ocean floor via the fastening elements of the self-fastening mechanism;

FIG. 12A shows a primary containment assembly including a self-fastening mechanism having a set of blades in accordance with an alternative to the second embodiment of the present invention;

FIG. 12B shows a top view of the primary containment assembly of FIG. 12A;

FIG. 12C shows a bottom view of the primary containment assembly of FIG. 12A with the blades of the self-fastening mechanism rotating;

FIG. 12D shows a side view of the primary containment assembly of FIG. 12A circumventing the defective BOP stack and fastened to the ocean floor via the blades of the self-fastening mechanism;

FIGS. 13A, 13B and 13C show examples of various secondary containment assemblies configured to be fastened between the primary containment assembly and at least one containment vessel floating on the ocean surface;

FIG. 14A shows a side view of the assembled first and second containment assemblies connected between the ocean floor and a containment vessel;

FIG. 14B shows a side view of assembled first and second containment assemblies connected between the ocean floor and an oil and/or gas routing device that is controlled to allow the oil and/or gas to be routed via one or more flexible containment sections in order to be stored by one or more respective containment vessels;

FIG. 15 is a flow diagram of a procedure for containing oil and/or gas spewing from a defective BOP stack using the primary and secondary containment assemblies of FIGS. 11A-11D, 12A-12D and 13A-13C;

FIG. 16 shows a side view of a primary containment assembly configured to receive “top kill” cement and/or mud via a first set of top kill valves, while regulating the output of the leaking oil and/or gas via a valve on an upper opening in accordance with a third embodiment of the present invention;

FIG. 17 shows a side view of a primary containment assembly having a hollow steel-reinforced wall configured to receive wall reinforcement material via a set of wall reinforcement valves, and a second set of top kill valves configured to receive top kill cement and/or mud to fill a bottom portion of the primary containment assembly, while regulating the output of the leaking oil and/or gas via a valve on a heated upper opening in accordance with a fourth embodiment of the present invention; and

FIG. 18 is a flow diagram of a procedure for containing oil and/or gas spewing from a defective BOP stack using the primary containment assembly of FIG. 17.

### DETAILED DESCRIPTION

The present invention described herein, otherwise known as the “BOPstopper”, proposes the undertaking of a potentially expensive method and apparatus, due to the substantially large size of a defective BOP stack that must be circumvented and sealed under thousands of feet of water in response to a catastrophic event, such as the Deepwater Horizon oil spill. However, it has recently been discovered that there are currently no procedures or apparatus available for effectively dealing with such events, and that the consequences of other similar events occurring over a period of time have the potential to destroy life on Earth as we know it.

Instead of tapping off various points of the defective BOP stack 120′, the BOPstopper uses its various embodiments to substantially isolate the BOP stack 120′ from the ocean by completely circumventing and encasing the defective BOP stack 120′. Thus, the amount of ocean that mixes with the spewing oil and/or gas 210 is minimized. Furthermore, a combination of one or more heating elements and measurement equipment, as well as the addition of one or more valves, allows the BOPstopper to better contain and/or control the spewing oil and/or gas 210.

The BOPstopper contains oil from a subsea oil and/or gas blowout. An apparatus constructed from this design will mitigate the spread of oil slicks from subsea oil and/or gas blowouts, with the benefit of allowing oil and/or gas exploration to proceed with diminished risk of environmental damage. The BOPstopper has particular application where coastal wetlands or other delicate ecosystems may potentially be damaged by an oil spill. There currently appears to be no alternative method or apparatus for containing the oil from such blowouts. The BOPstopper has market potential in basins subject to offshore oil exploration where deepwater rigs are active.

The reinforcement material mentioned herein, such as cement, is used underwater for many purposes including, for example, in pools, dams, piers, retaining walls and tunnels. There are many factors that must be controlled for successful application of cement underwater. Of these, the hardening time, that between mixing and solidification, is particularly important because, if it is too long, the cement does not solidify at all but simply dissolves in the surrounding water, herein the environmental water. Compositions containing exothermic micro particles have been found very advantageous for underwater cement applications. The exothermic micro particles produce very high rates of exothermic heating when combined with base cement and water. The exothermic heat produced is sufficient to raise the reaction temperature to a point where the cement composition solidifies underwater, even in cold environmental water.

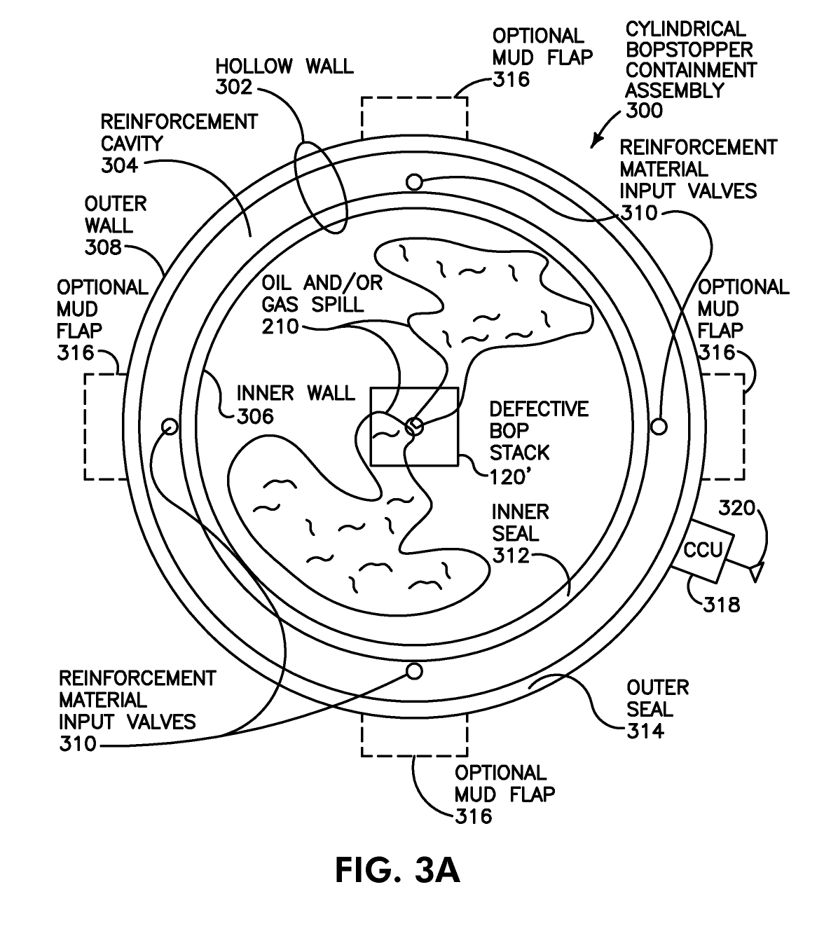

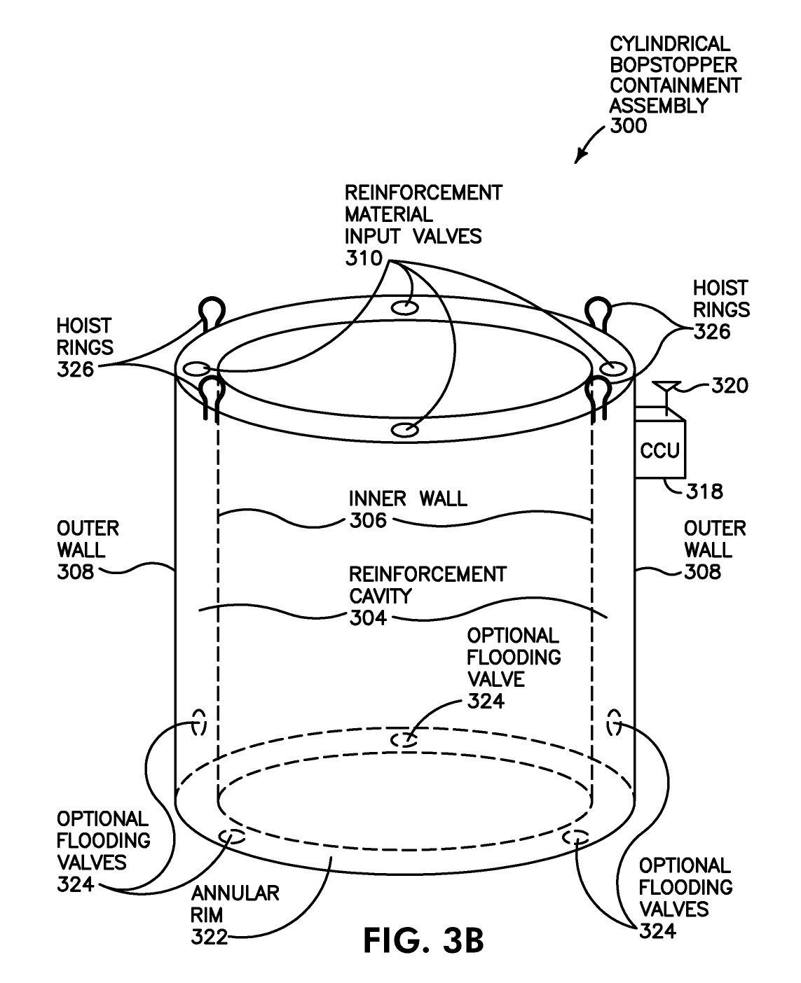

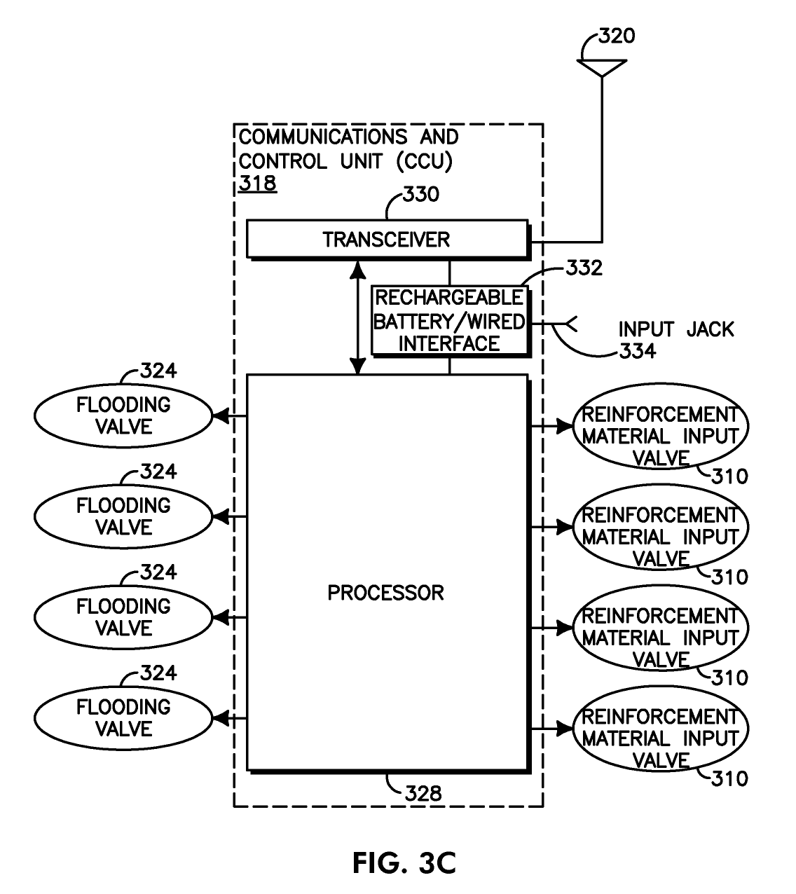

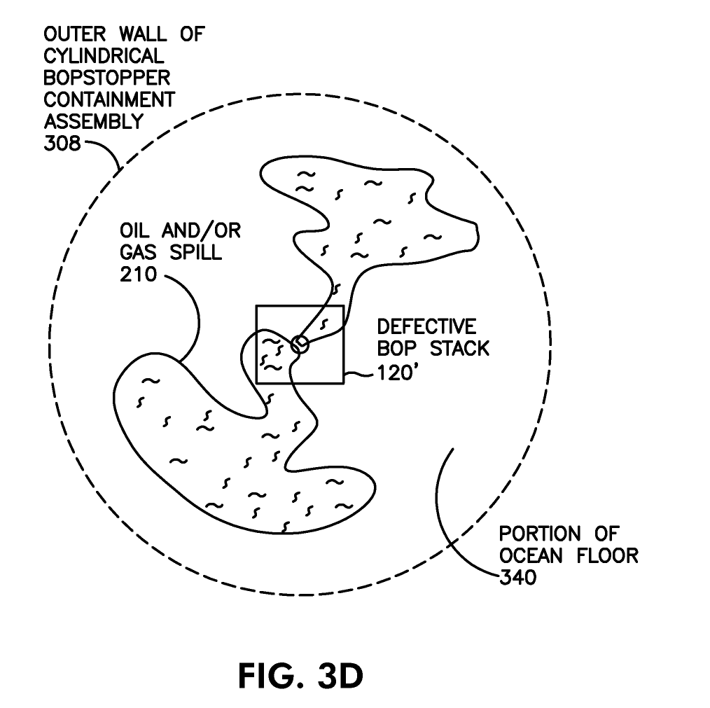

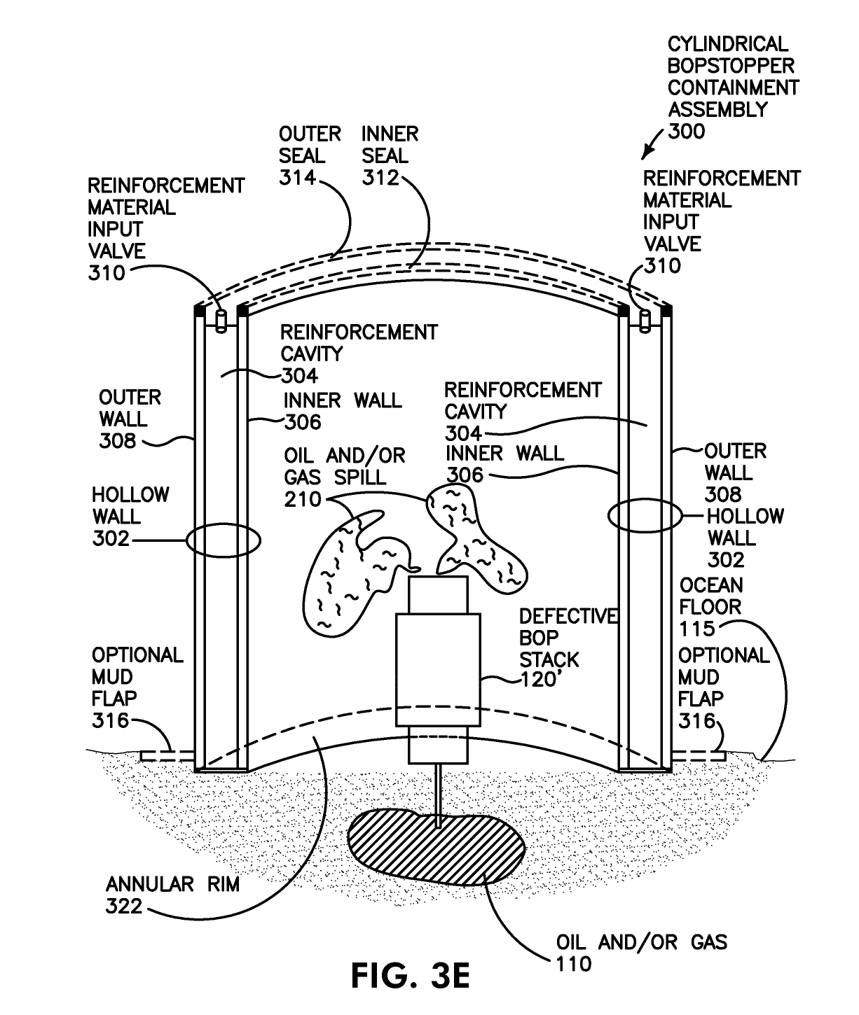

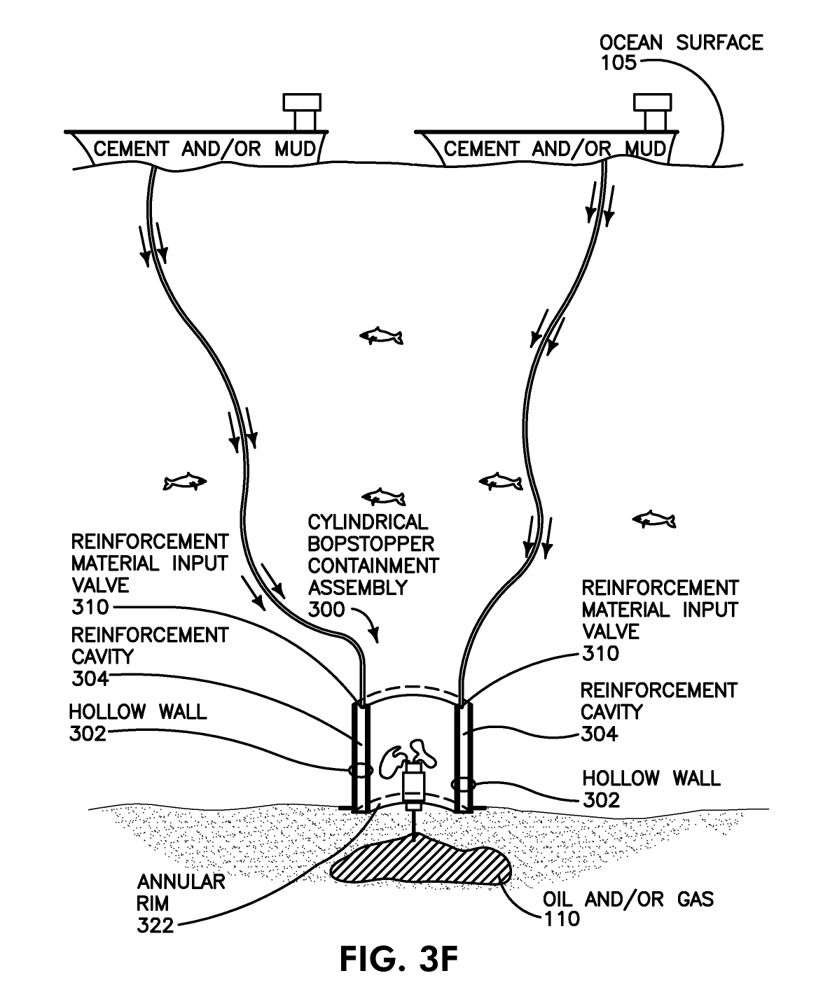

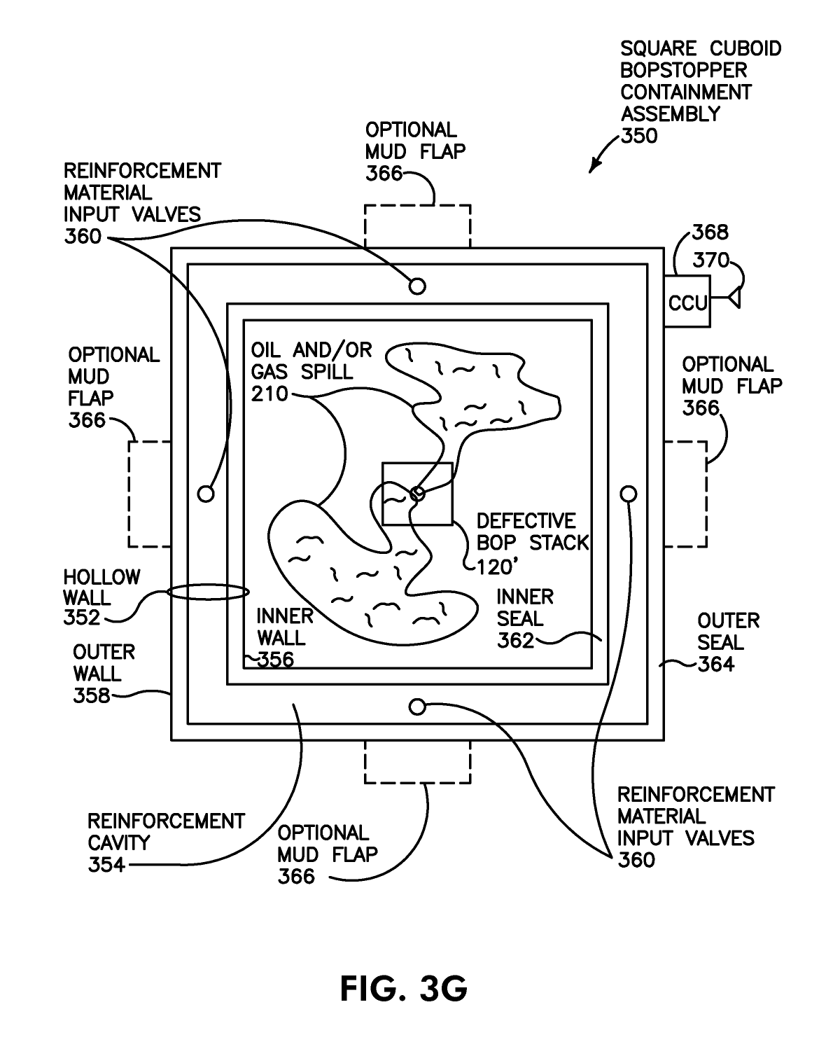

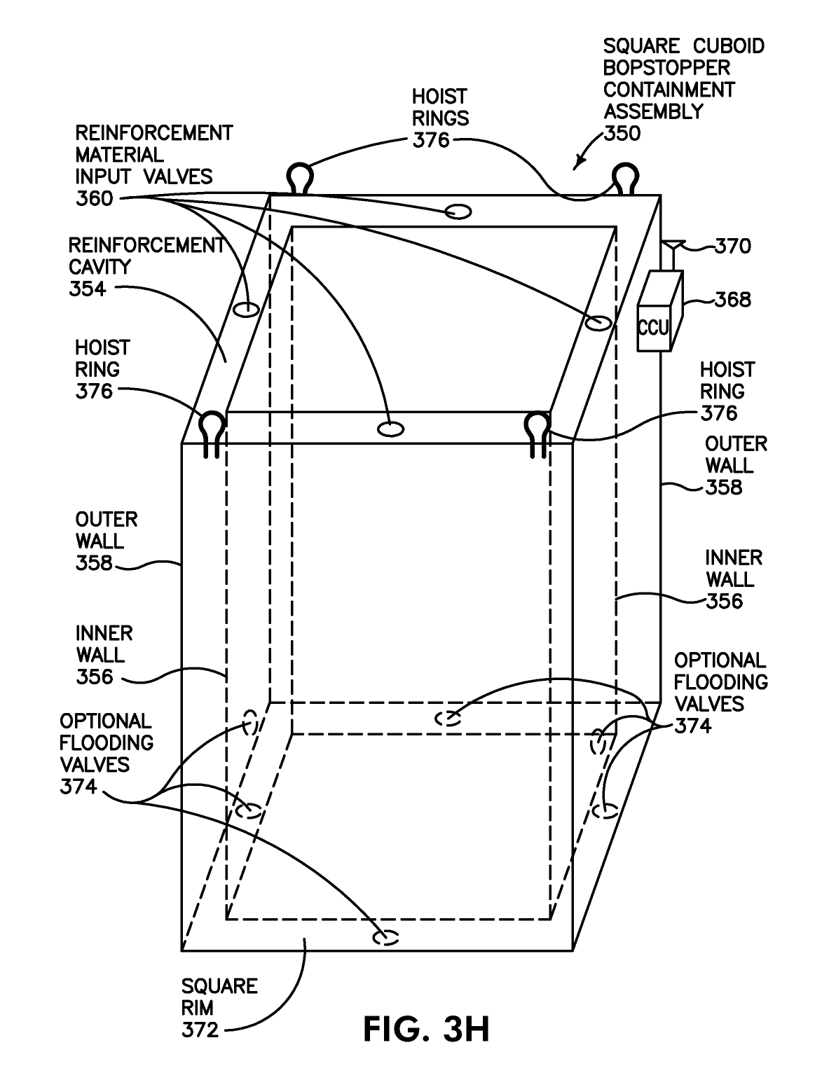

FIG. 3A shows a top view of a cylindrical BOPstopper containment assembly 300 that is configured in accordance with a first embodiment of the present invention. The cylindrical BOPstopper containment assembly 300 has a hollow wall 302 comprising a reinforcement cavity 304 between an inner wall 306 and an outer wall 308, as well as a set of reinforcement material input valves 310 located near the top perimeter of the hollow wall 302 for filling the reinforcement cavity 304 with reinforcement material (e.g., cement and/or mud).

The inner wall 306 and the outer wall 308 may be steel-reinforced, or consist of any other metal of a suitable strength and thickness. The cylindrical BOPstopper containment assembly 300 may further comprise at least one seal (e.g., an inner seal 312 and an outer seal 314) that is mounted along the entire top perimeter of the hollow wall 302. Optionally, the cylindrical BOPstopper containment assembly 300 may include one or more mud flaps 316 to stop the cylindrical BOPstopper containment assembly 300 from sinking too far below the ocean floor 115, especially after the reinforcement cavity 304 is filled with reinforcement material. The cylindrical BOPstopper containment assembly 300 may further comprise a CCU 318 and at least one antenna 320.

A more sophisticated system of mud flaps 316 may be implemented, whereby the mud flaps 316 may be located at different heights along the outer wall 308 of the cylindrical BOPstopper containment assembly 300, and may be remotely activated (either wirelessly or via a wired or hydraulic connection from a vessel floating on the ocean surface 105) to protrude or retract, or be raised or lowered, to control the depth of the cylindrical BOPstopper containment assembly 300 as more weight is added on top of it in order to contain the spewing oil and/or gas 210. Furthermore, the mud flaps 316 may be designed to break off, based on how much weight is applied to the top perimeter of the hollow wall 302 of the cylindrical BOPstopper containment assembly 300.

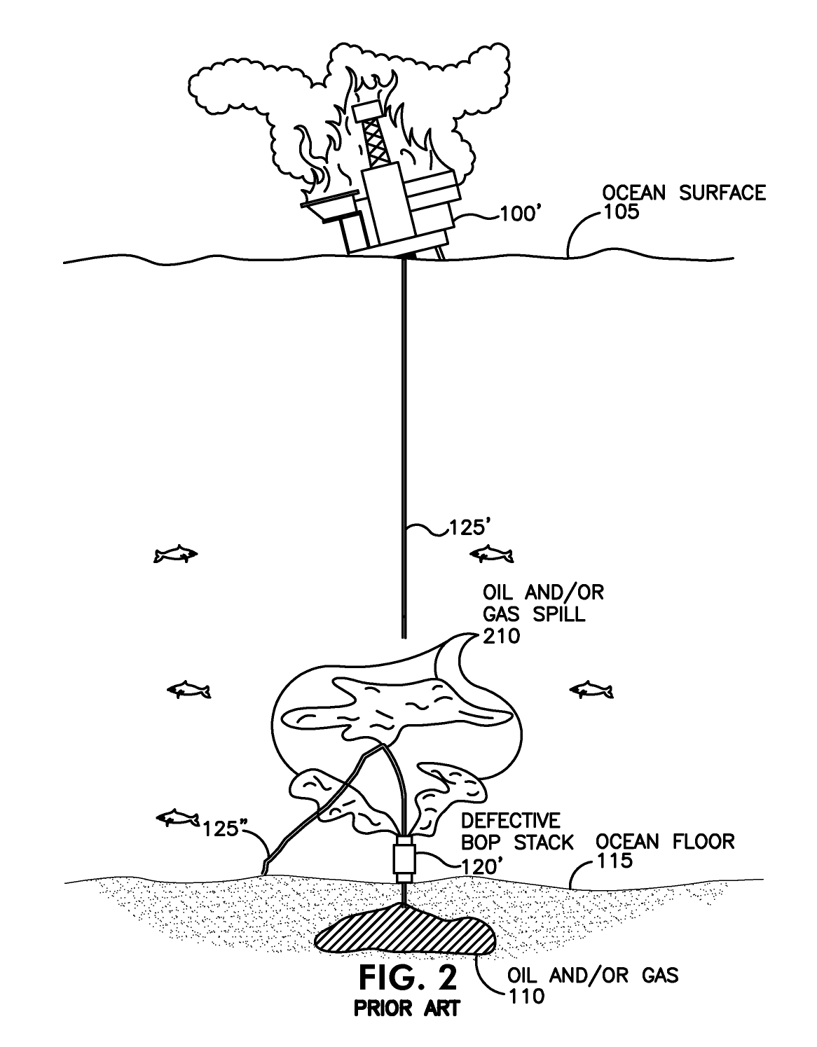

The cylindrical BOPstopper containment assembly 300 is submerged below the ocean surface 105 and positioned on a portion of the ocean floor 115 that circumvents a defective BOP stack 120′. Although it may be possible to position the cylindrical BOPstopper containment assembly 300 to circumvent the defective BOP stack 120′ if the riser assembly 125 remains in a vertical position by letting the riser assembly 125 pass through the center of the cylindrical BOPstopper containment assembly 300, the riser assembly 125 needs to be disconnected (i.e., cut off) near the top of the defective BOP stack 120′ if a catastrophic event caused the riser assembly 125 to collapse (i.e., fold over), as what occurred due to the Deepwater Horizon drilling rig explosion (see FIG. 2).

Alternatively, the cylindrical BOPstopper containment assembly 300 may consist of a plurality of sections and/or components that may be constructed and stored onshore close to areas where deepwater rigs are active. The sections and/or components may include seals and/or gaskets, and may be assembled together as they are submerged just under the ocean surface 105.

FIG. 3B shows a side view of the cylindrical BOPstopper containment assembly 300 of FIG. 3A. As shown in FIG. 3B, the cylindrical BOPstopper containment assembly 300 further comprises an annular rim 322 that connects the bottom of the inner wall 306 to the bottom of the outer wall 308. Optionally, the cylindrical BOPstopper containment assembly 300 may comprise a plurality of flooding valves 324, which may be located on the outer wall 308 and/or on the annular rim 322. The cylindrical BOPstopper containment assembly 300 may further comprise a plurality of hoist rings 326 that may be used during the submersion and positioning of the cylindrical BOPstopper containment assembly 300 by a vessel floating on the ocean surface 105, and/or by at least one remotely operated vehicle (ROV).

Preferably, the reinforcement material input valves 310 and the flooding valves 324 may be configured to be remotely controlled (either wirelessly or via a wired or hydraulic connection from a vessel floating on the ocean surface 105) to maintain an open position, a partially open position or a closed position, as desired.

FIG. 3C is a block diagram of the CCU 318 of the cylindrical BOPstopper containment assembly 300 of FIGS. 3A and 3B. As shown in FIG. 3C, the CCU 318 includes a processor 328, a transceiver 330, and a rechargeable battery/wired interface 332. The processor 328 is configured to control the reinforcement material input valves 310 and the flooding valves 324 of the cylindrical BOPstopper containment assembly 300, either wirelessly or via a wired interface, such that they may be maintained in an open position, a partially open position or a closed position, as desired. The CCU 318 may communicate with a vessel floating on the ocean surface 105 via the transceiver 330 and the at least one antenna 320. A ROV and/or a vessel floating on the ocean surface 105 may recharge the battery 332 and/or directly provide the necessary voltage and current, via an input jack 334, to power the processor 328 and the transceiver 330. Various communication techniques, such as very low frequency radio techniques coupled with digital signal processing and digitally modulated radio communications methods, may be implemented to facilitate communications via the antenna 320. Alternatively, various types of radio frequency (RF), optic and acoustic communication methods, as well as wired (umbilical) technologies, may be implemented for deep water communications between the vessel floating on the ocean surface 105 and the cylindrical BOPstopper containment assembly 300.

FIG. 3D shows a top view of the defective BOP stack 120′ and a portion 340 of the ocean floor 115 that the cylindrical BOPstopper containment assembly 300 of FIGS. 3A and 3B may be positioned on to circumvent the defective BOP stack 120′. It would be desirable to grade the portion 340 of the ocean floor 115 surrounding the defective BOP stack 120′, which is to be circumvented by the outer wall 308 of the cylindrical BOPstopper containment assembly 300, before the cylindrical BOPstopper containment assembly 300 is positioned on it, in order to optimize the reduction of the pollution of the ocean caused by the oil and/or gas 210 spewing from the defective BOP stack 120′. Such ocean floor grading may be performed by at least one ROV.

FIG. 3E shows a cross-sectional view of the cylindrical BOPstopper containment assembly 300 of FIGS. 3A and 3B. The inner seal 312 and the outer seal 314 are shown being mounted along the entire top perimeter of the hollow wall 302 of the cylindrical BOPstopper containment assembly 300. The reinforcement material input valves 310 are also shown as being located near the top perimeter of the hollow wall 302 of the cylindrical BOPstopper containment assembly 300.

FIG. 3F shows a cross-sectional view of the reinforcement cavity 304 (above the annular rim 322 of the cylindrical BOPstopper containment assembly 300) being filled with reinforcement material (e.g., cement and/or mud). The advantage of the BOPstopper is that the extraordinary structural bulk and strength that is required to contain the pressure encountered under the ocean due to the spewing oil and/or gas 210 may be added after the components of a relatively enormous oil/gas containment structure are transported, submerged and positioned on the ocean floor 115.

Although a cylindrical geometry has been proposed for the BOPstopper containment assembly to minimize leakage of the spewing oil and/or gas 210 at joints (i.e., corners) of a containment system, any other geometric configuration may be used. For example, FIG. 3G shows a top view of a square cuboid BOPstopper containment assembly 350 that is also configured in accordance with the first embodiment of the present invention, and FIG. 3H shows a side view of the square cuboid BOPstopper containment assembly 350 of FIG. 3G.

As shown in FIG. 3G, the square cuboid BOPstopper containment assembly 350 has a hollow wall 352 comprising a reinforcement cavity 354 between an inner wall 356 and an outer wall 358, as well as a set of reinforcement material input valves 360 located near the top perimeter of the hollow wall 352 for filling the reinforcement cavity 354 with reinforcement material (e.g., cement and/or mud). The square cuboid BOPstopper containment assembly 350 may further comprise at least one seal (e.g., an inner seal 362 and an outer seal 364) that is mounted along the entire top perimeter of the wide hollow wall 352. Optionally, the square cuboid BOPstopper containment assembly 350 may include one or more mud flaps 366 to stop the square cuboid BOPstopper containment assembly 350 from sinking too far below the ocean floor 115, especially after the reinforcement cavity 354 is filled with reinforcement material. The square cuboid BOPstopper containment assembly 350 may further comprise a CCU 368 and at least one antenna 370.

As shown in FIG. 3H, the square cuboid BOPstopper containment assembly 350 further comprises a square rim 372 that connects the bottom of the inner wall 356 to the bottom of the outer wall 358. Optionally, the square cuboid BOPstopper containment assembly 350 may comprise a plurality of flooding valves 374, which may be located on the outer wall 358 and/or on the square rim 372. The square cuboid BOPstopper containment assembly 350 may further comprise a plurality of hoist rings 376 that may be used during the submersion and positioning of the square cuboid BOPstopper containment assembly 350 by a vessel floating on the ocean surface 105, and/or by at least one ROV.

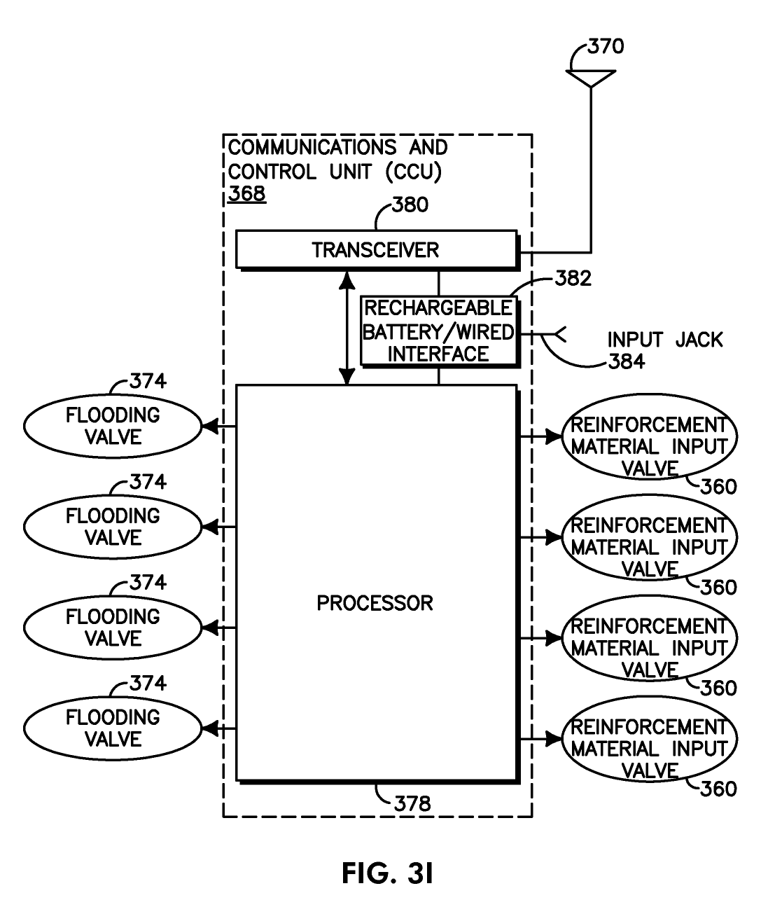

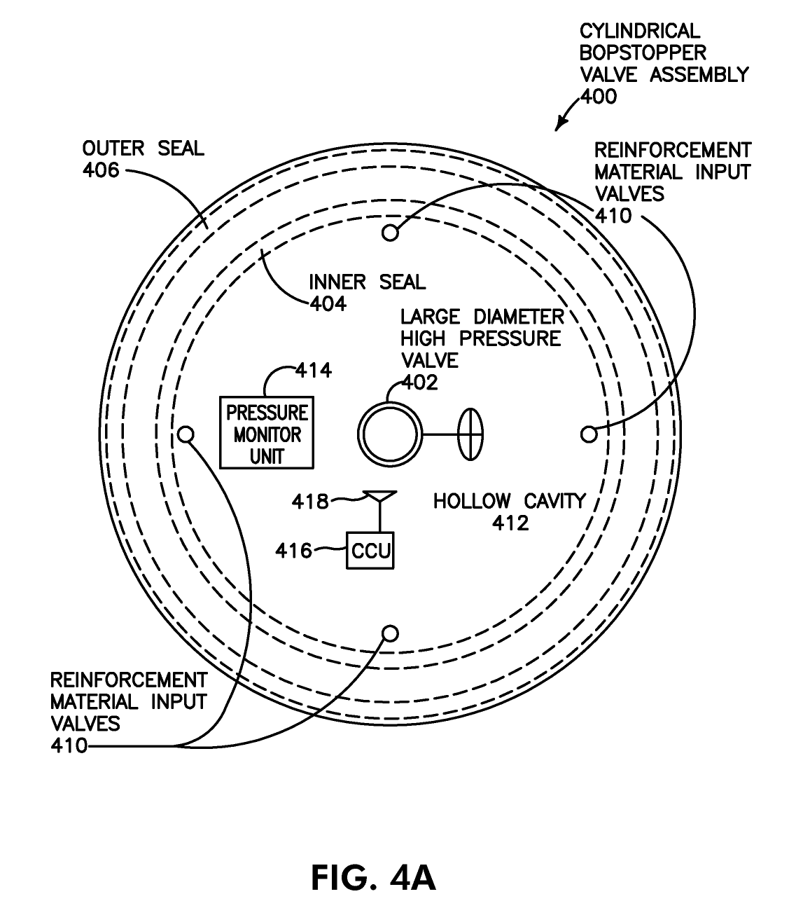

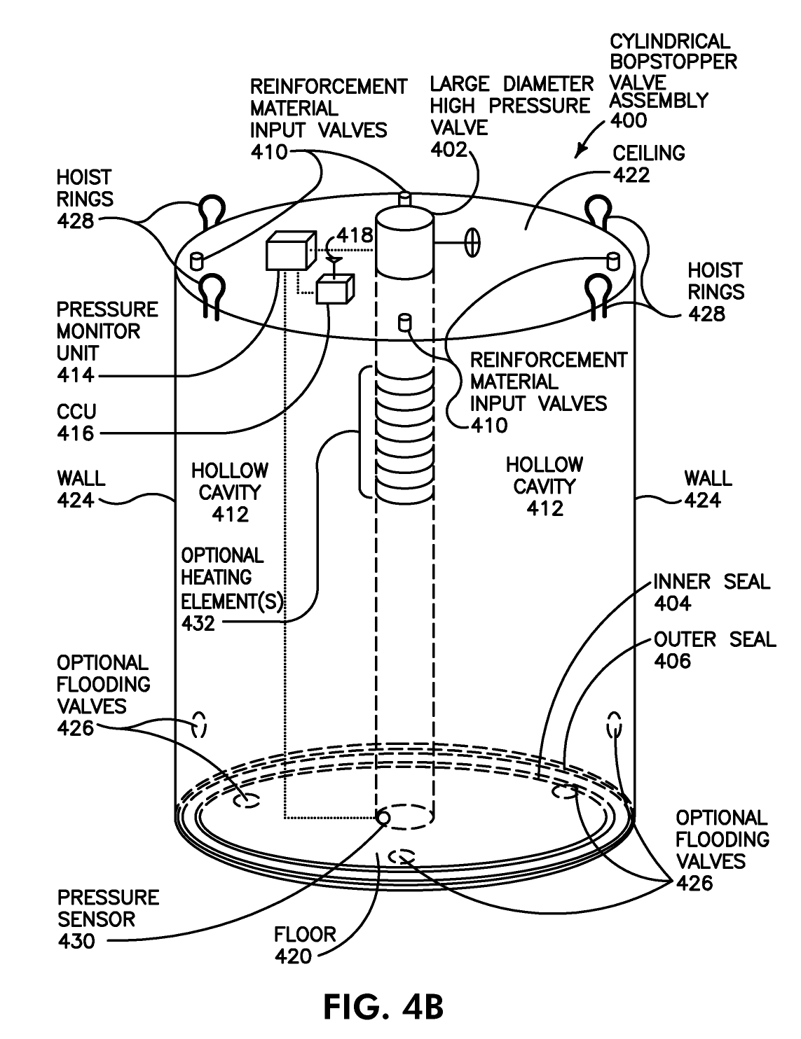

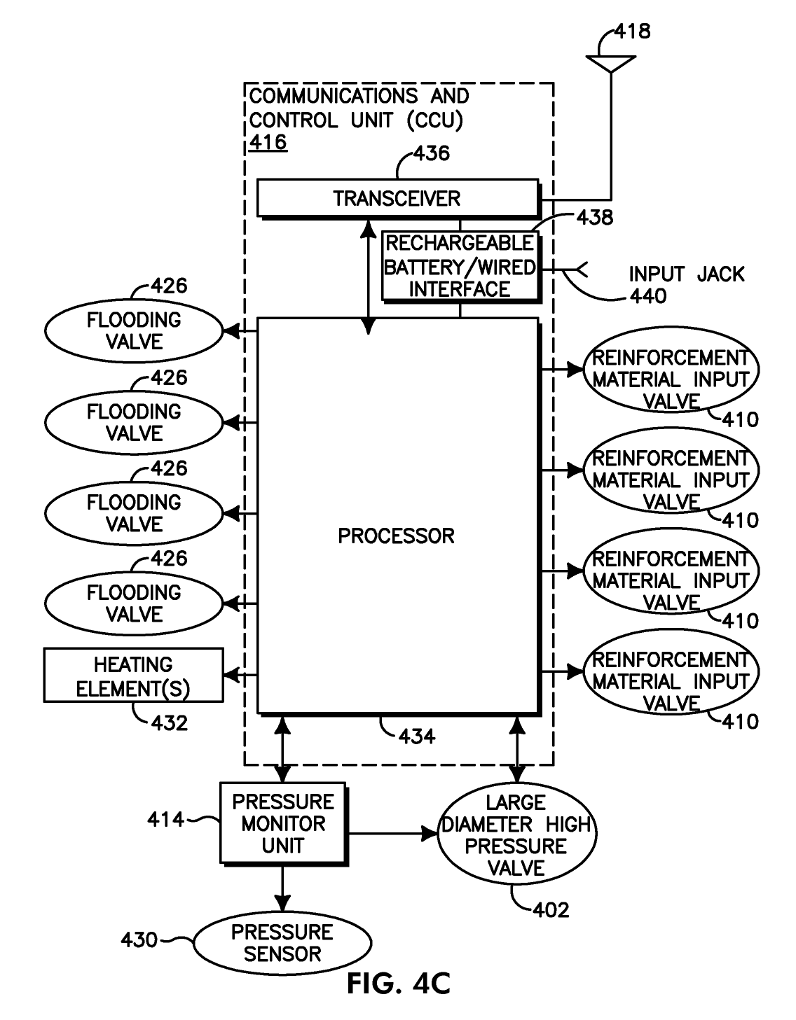

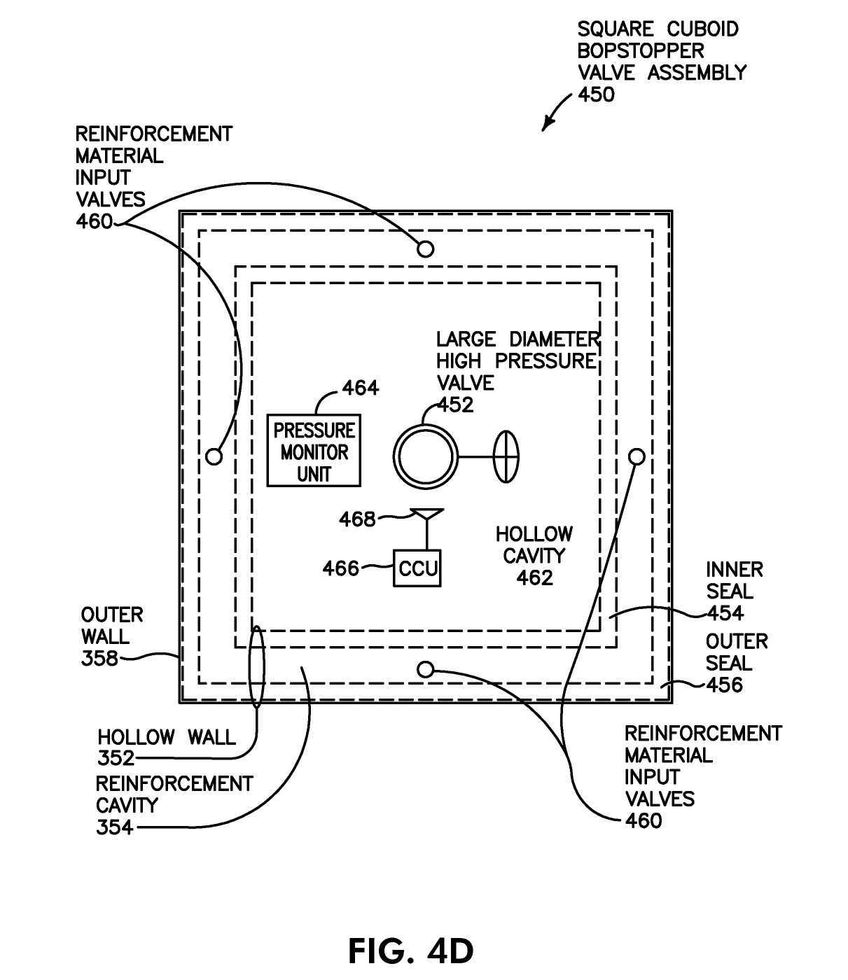

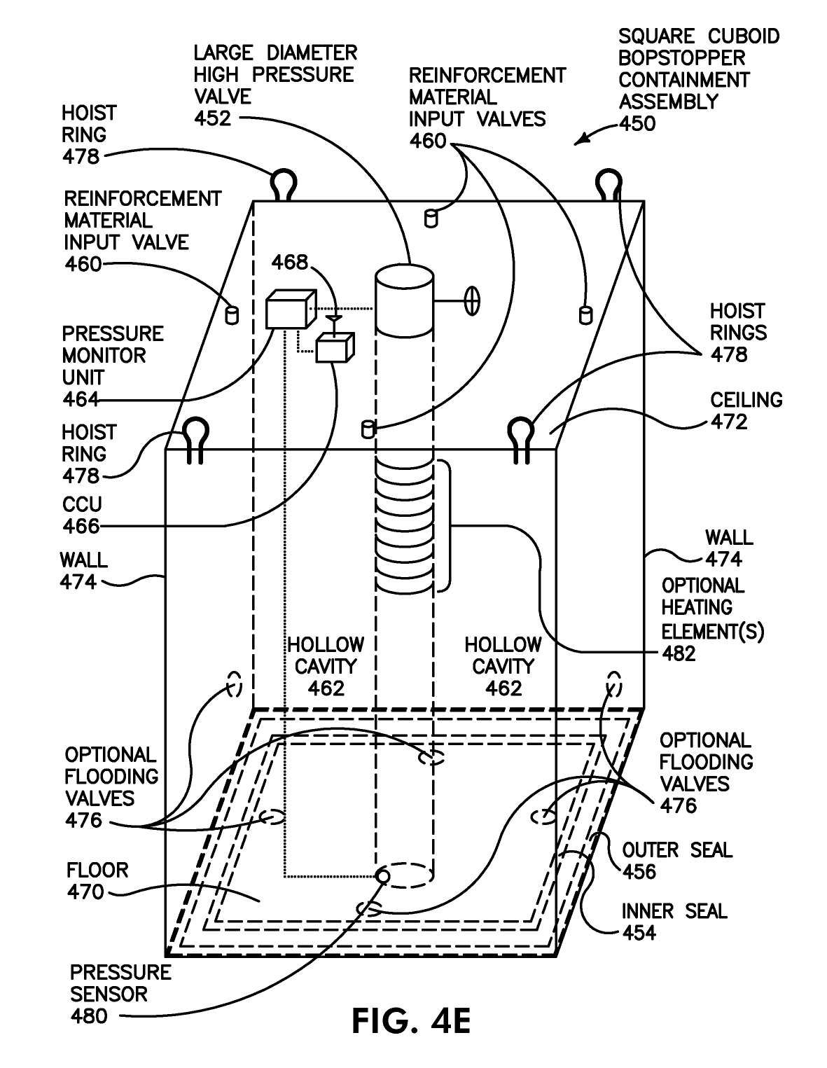

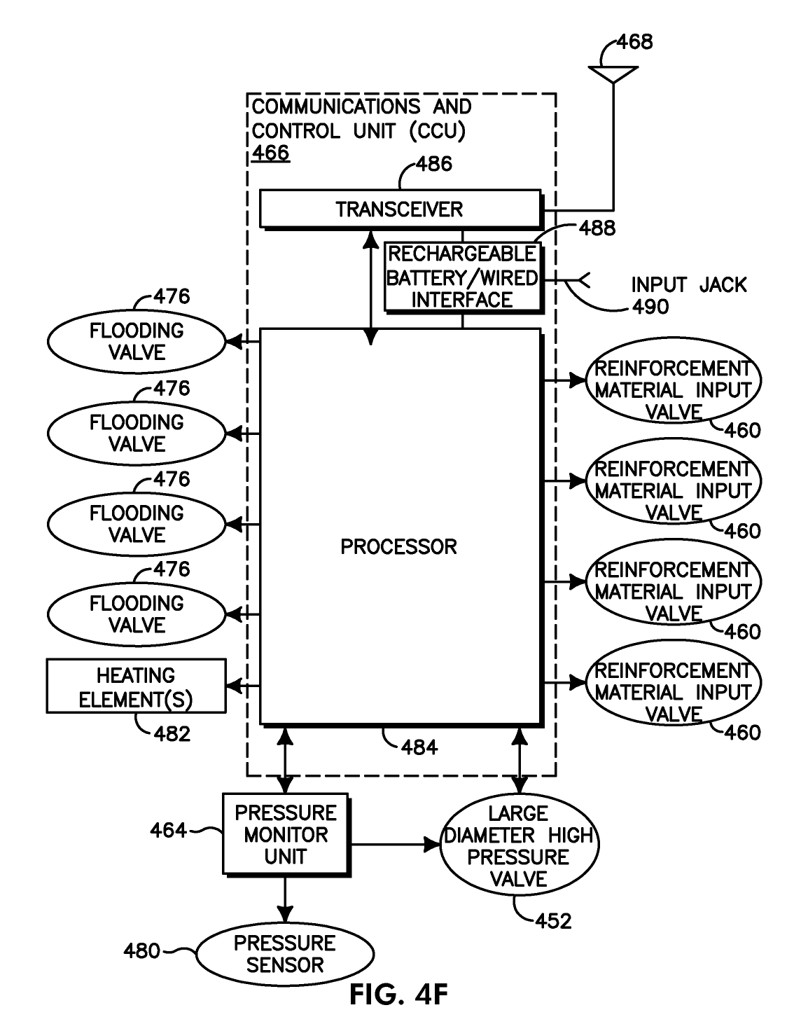

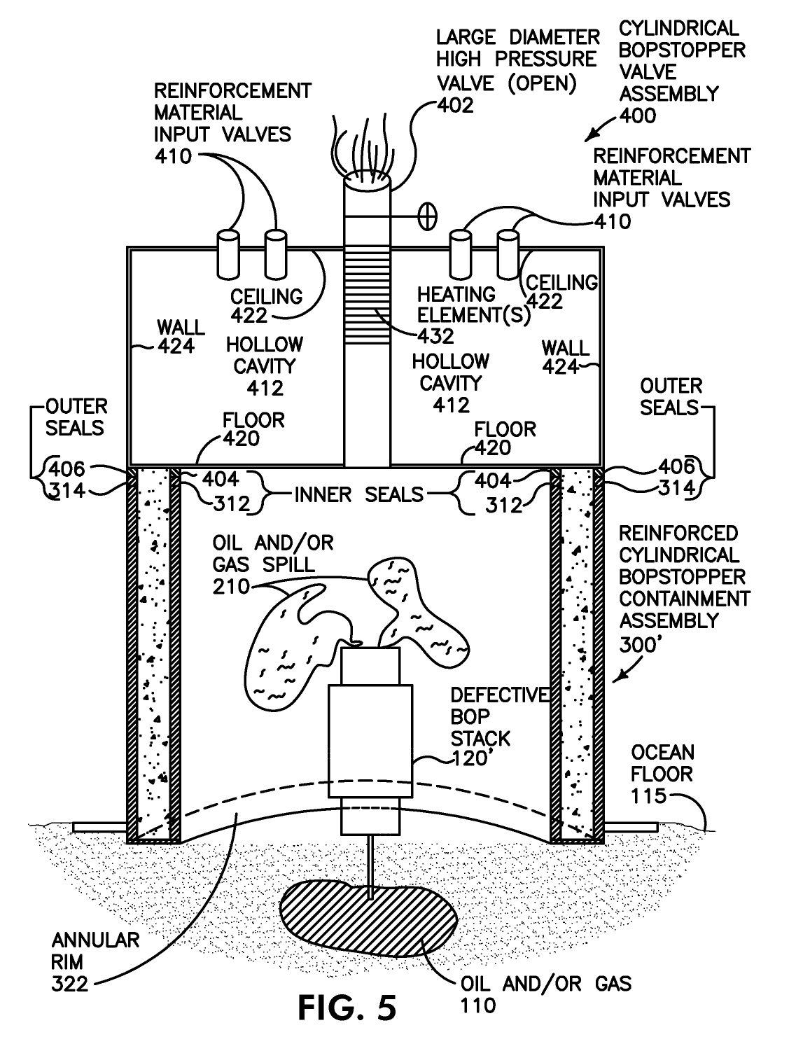

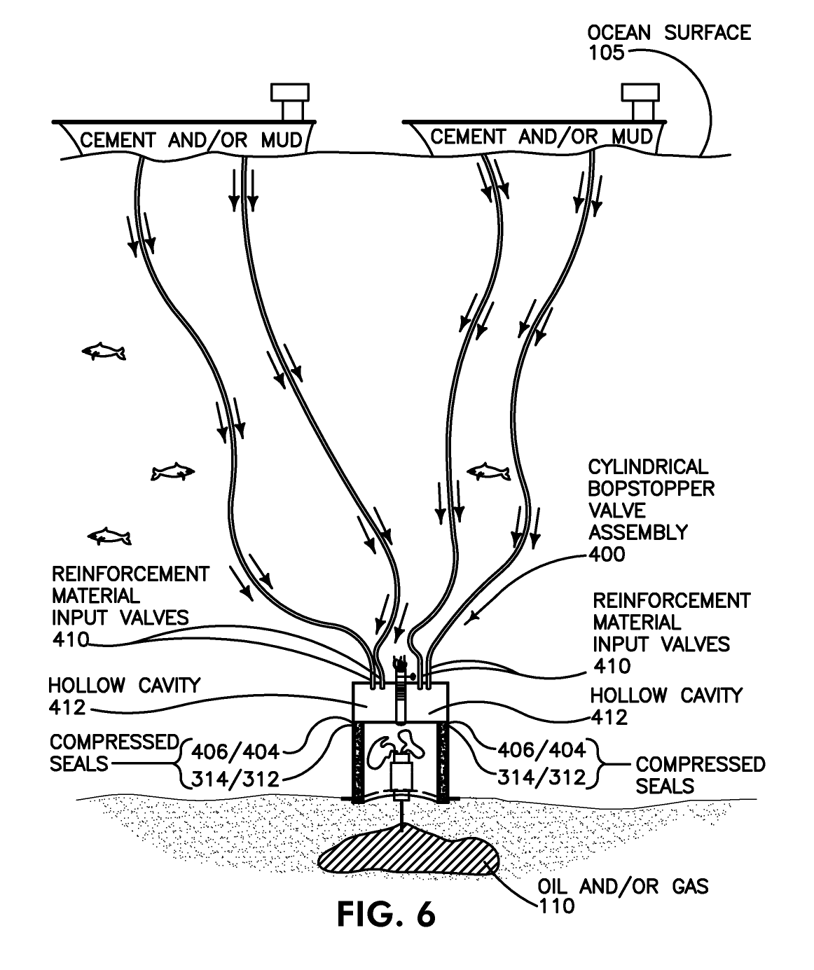

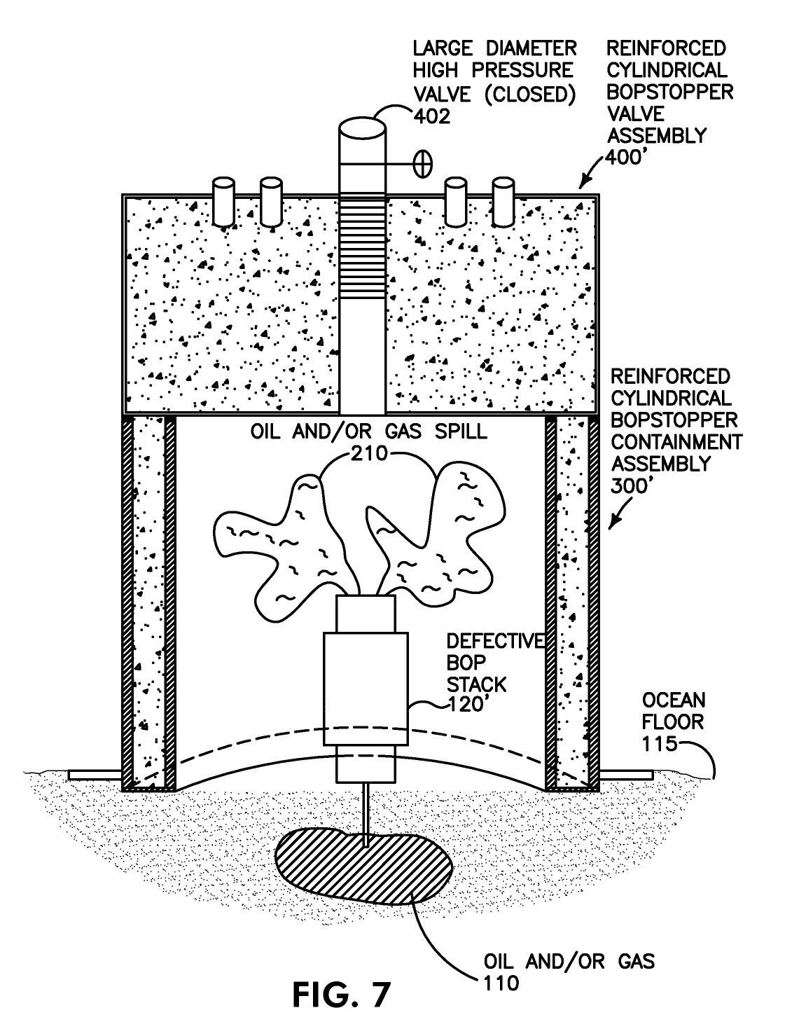

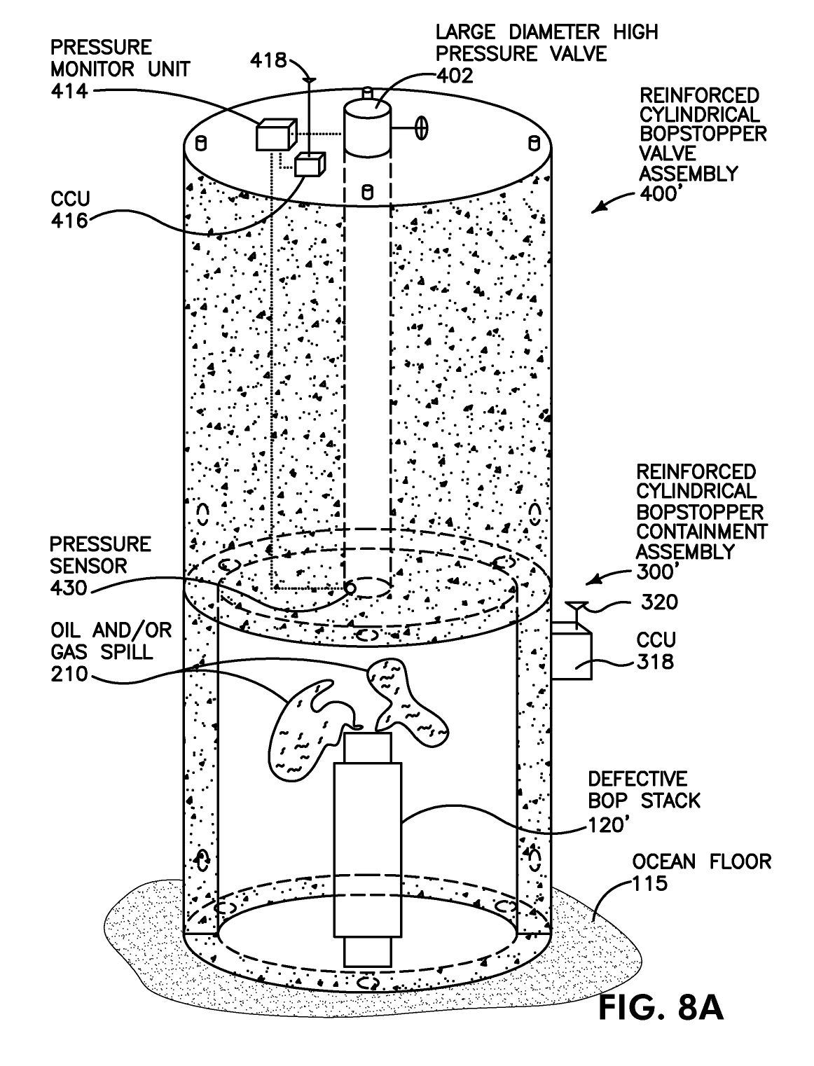

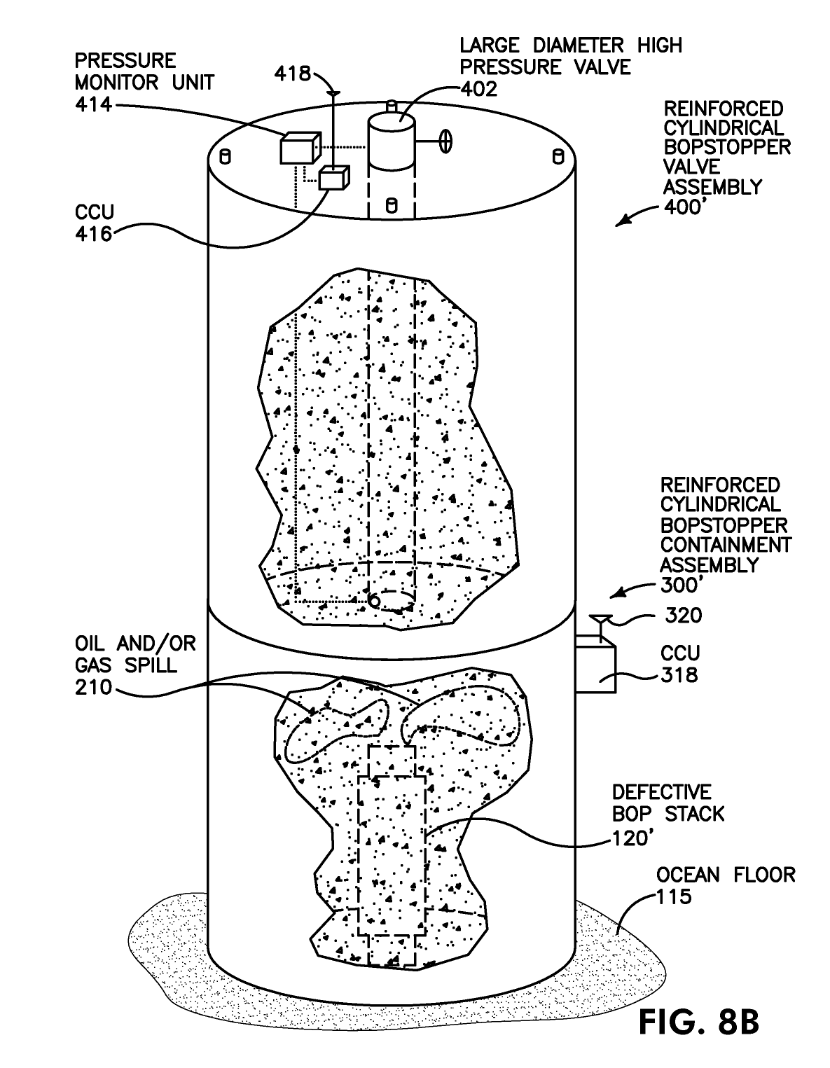

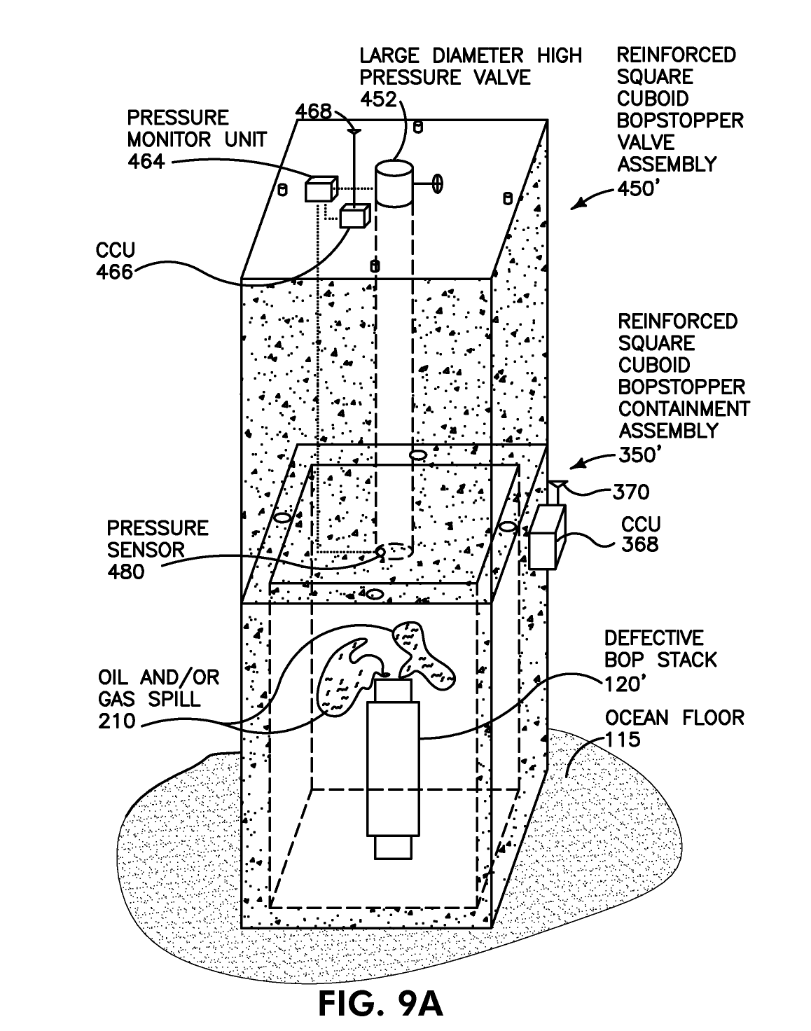

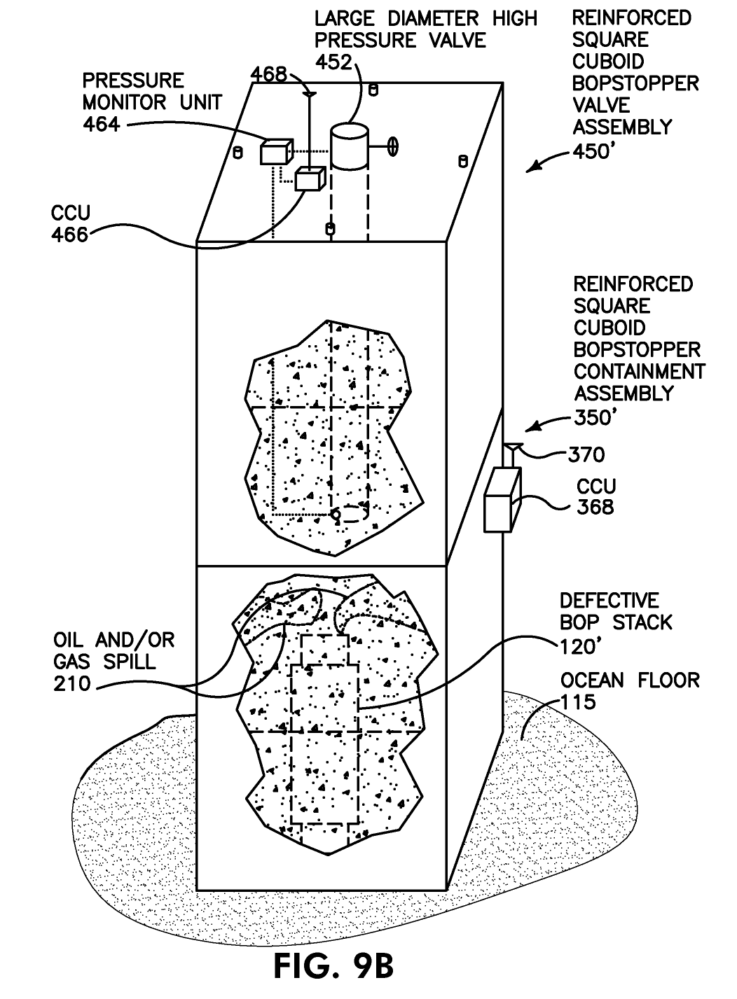

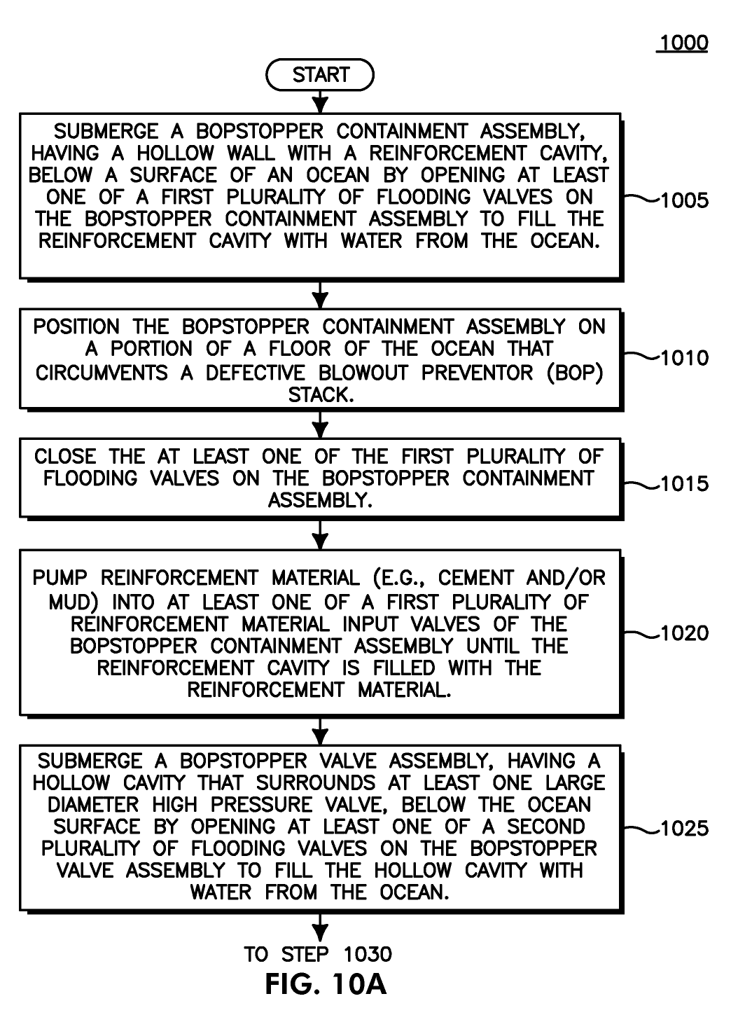

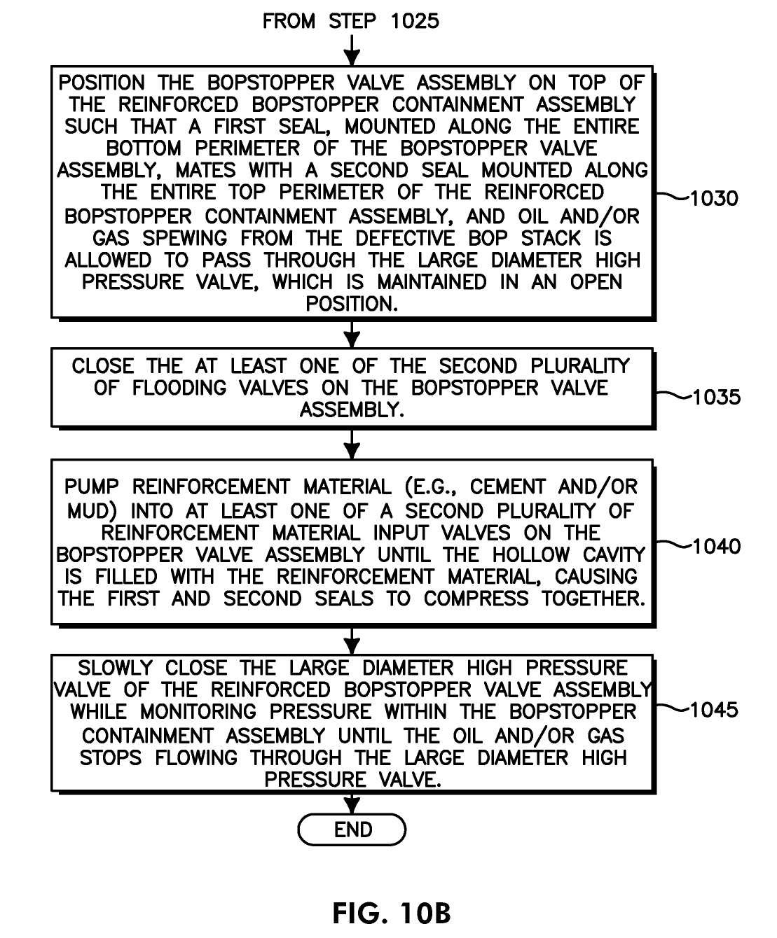

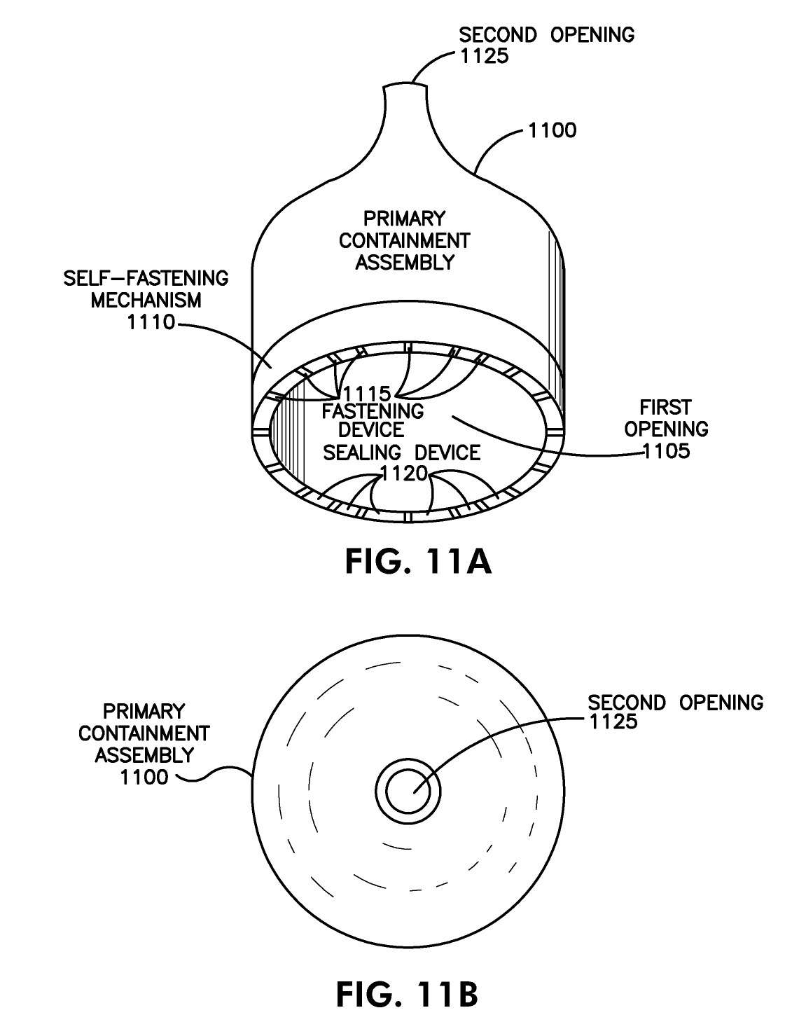

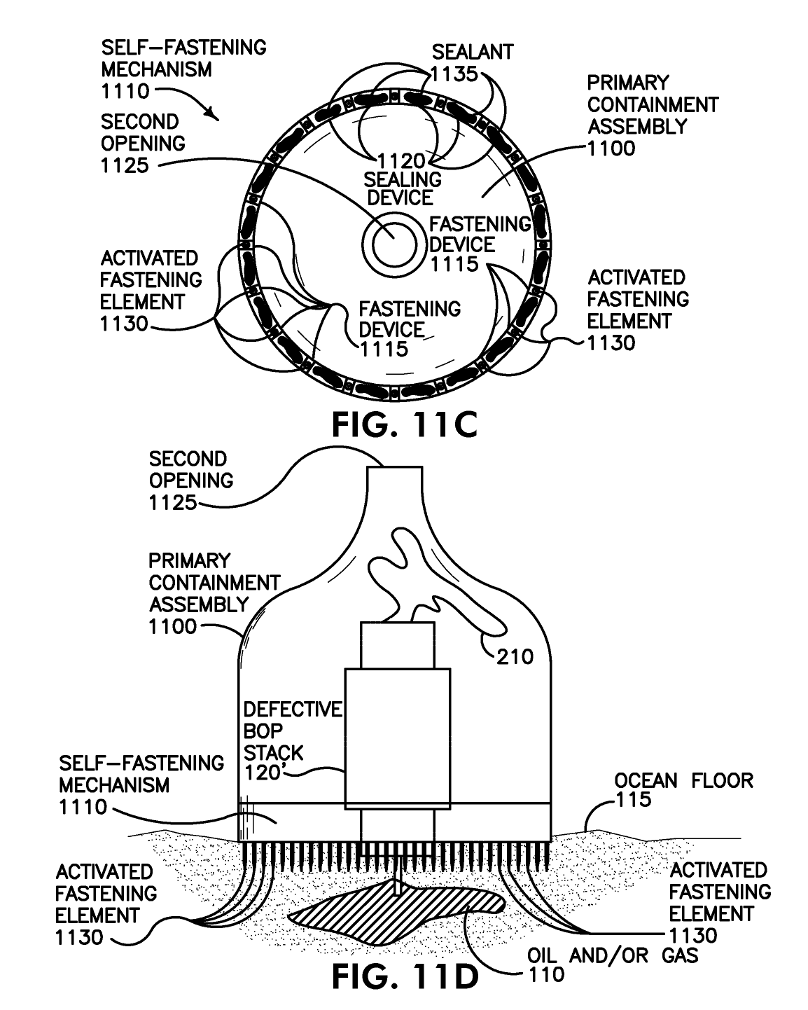

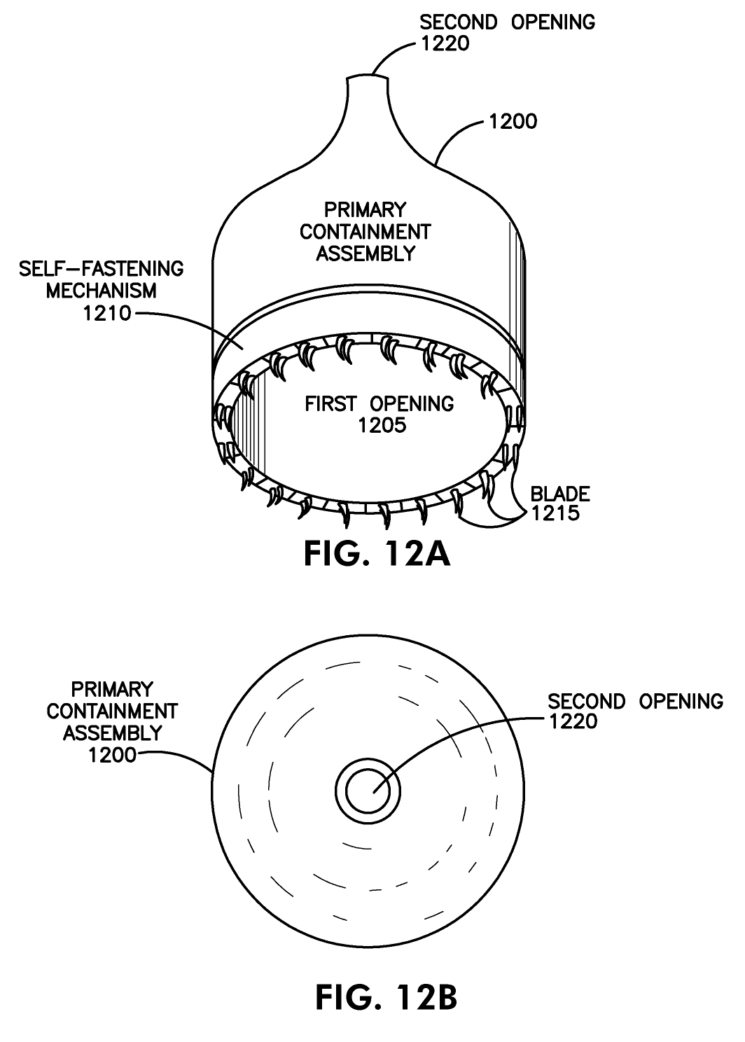

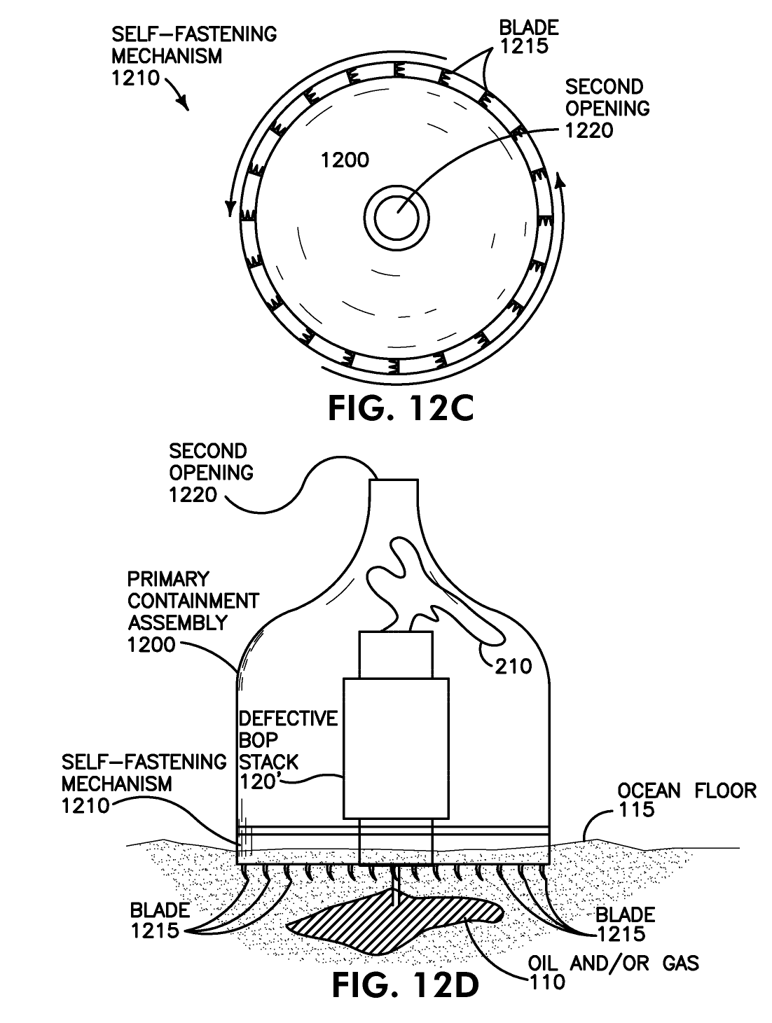

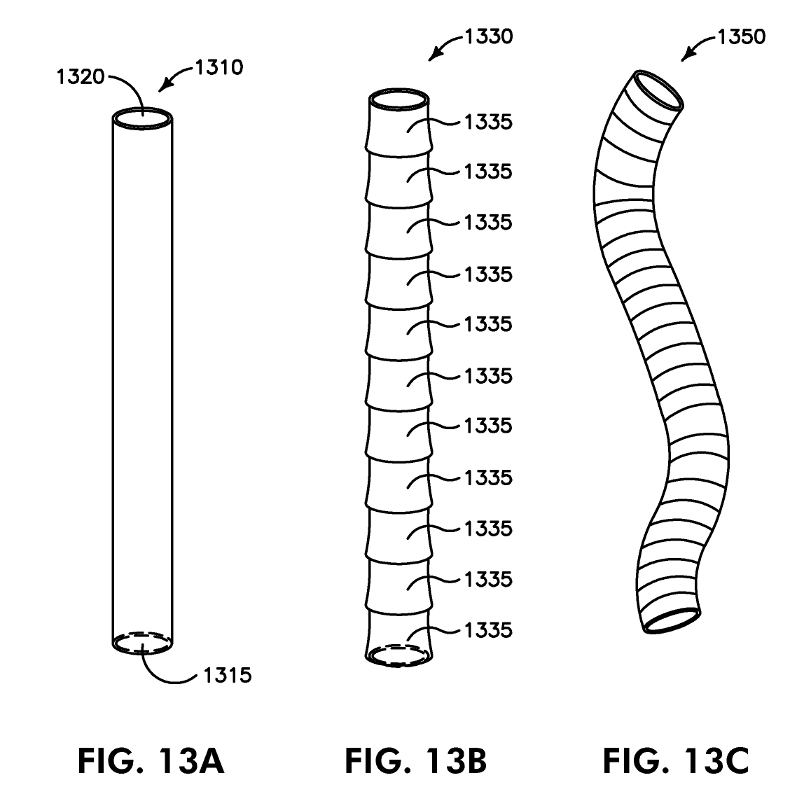

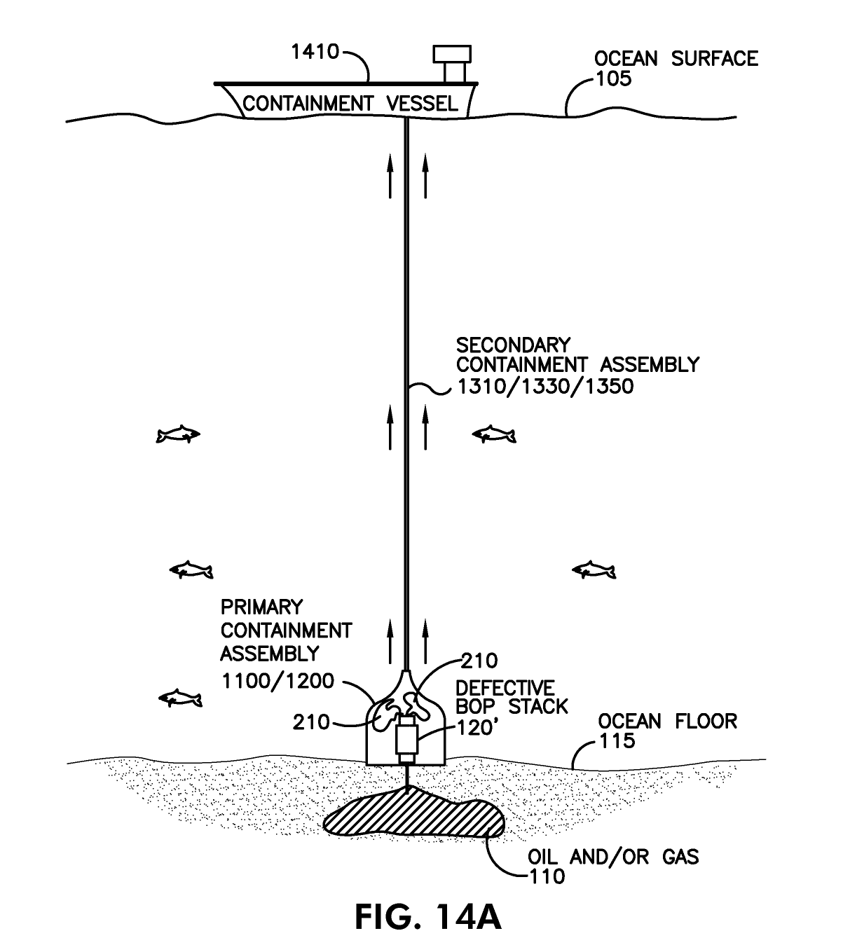

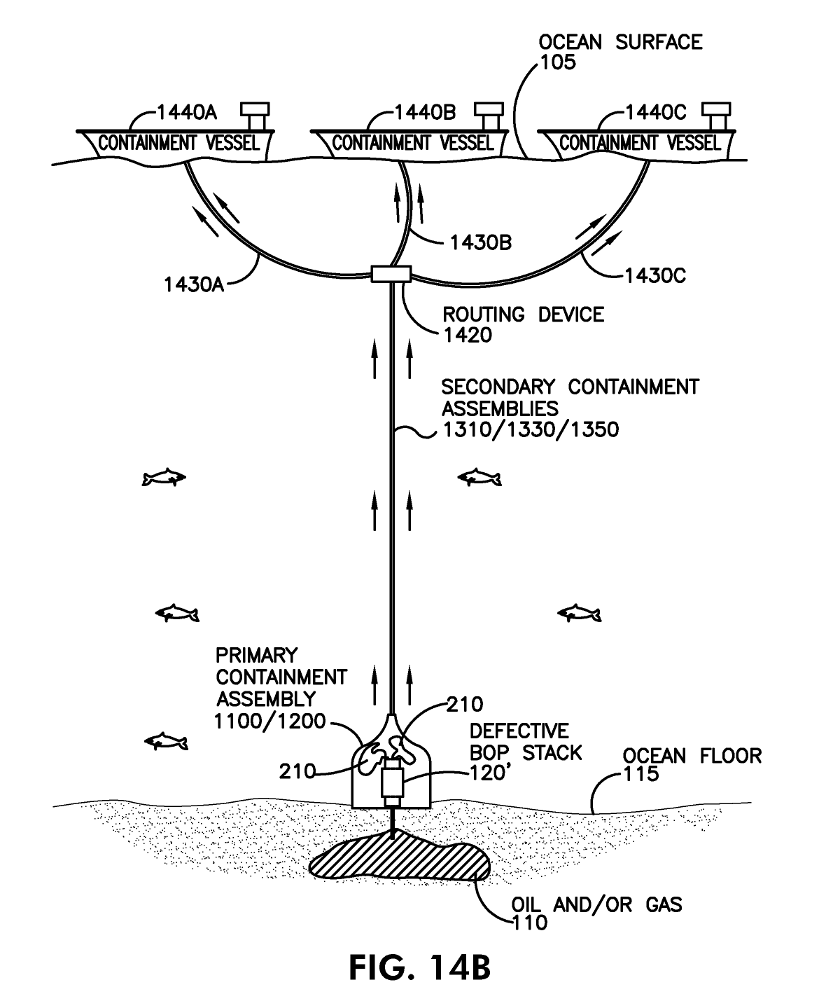

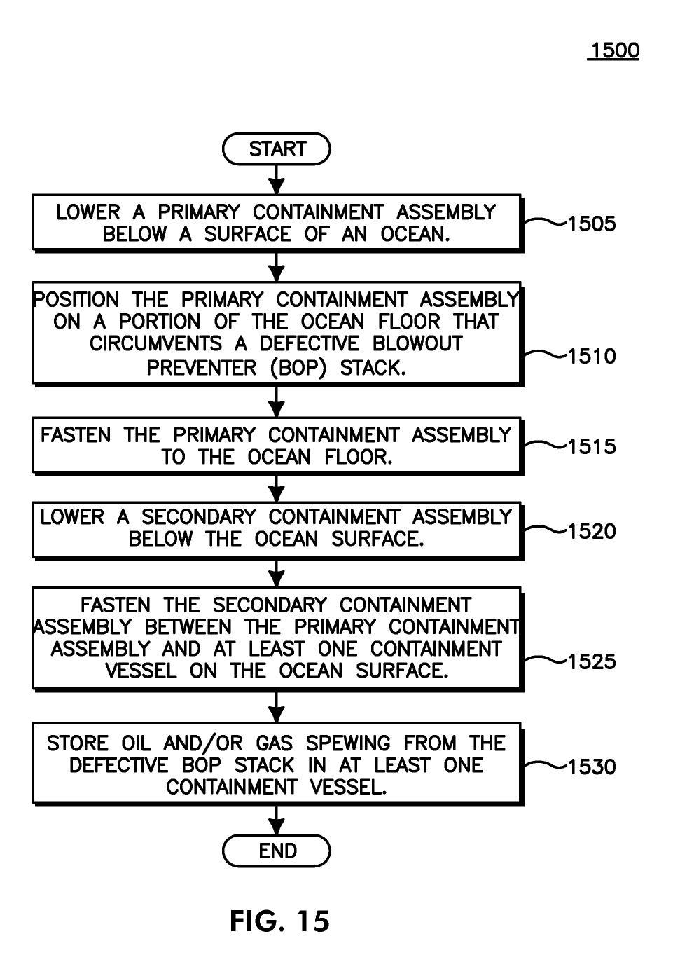

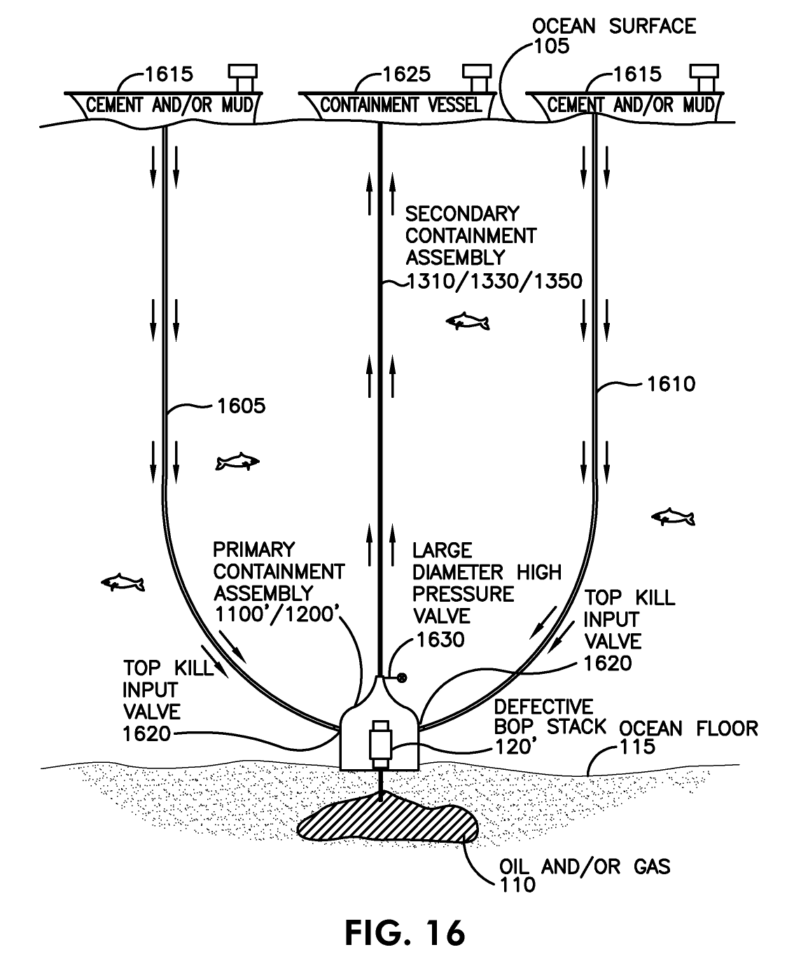

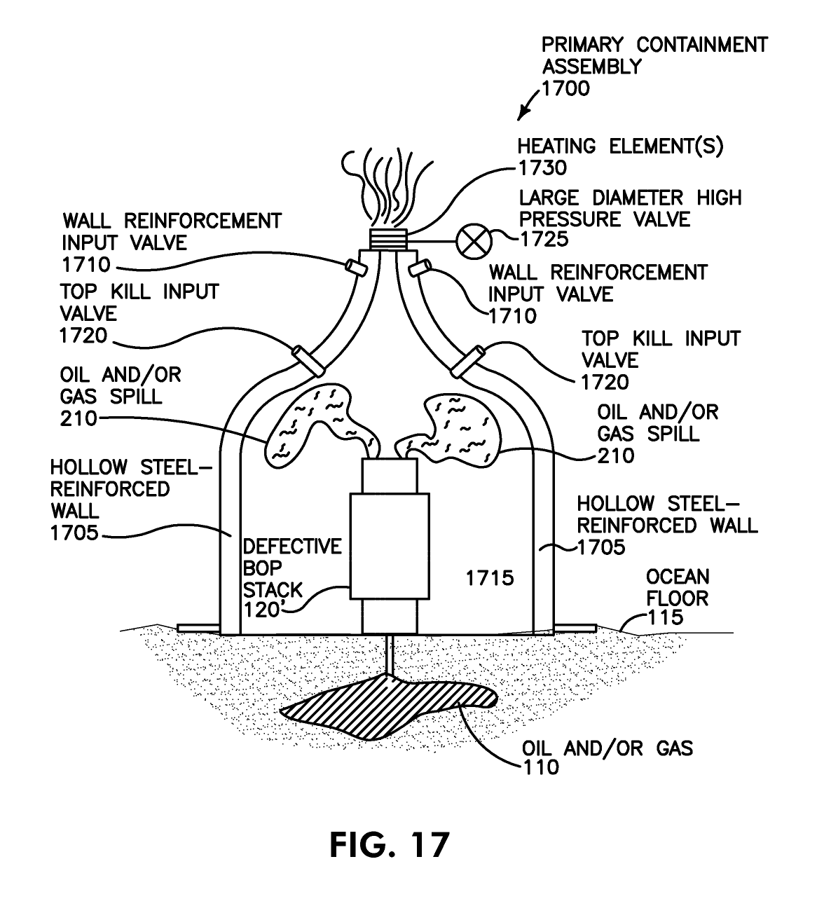

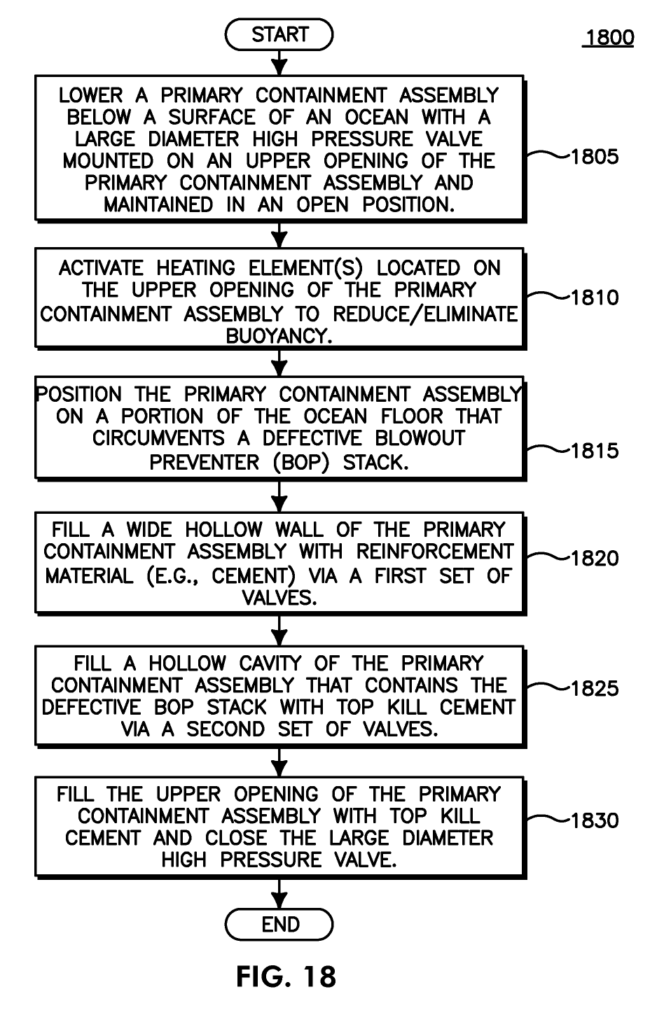

FIG. 31 is a block diagram of the CCU 368 of the square cuboid BOPstopper containment assembly 350 of FIGS. 3G and 3H. As shown in FIG. 31, the CCU 368 includes a processor 378, a transceiver 380, and a rechargeable battery/wired interface 382. The processor 378 is configured to control the reinforcement material input valves 360 and the flooding valves 374 of the square cuboid BOPstopper containment assembly 350, either wirelessly or via a wired interface, such that they may be maintained in an open position, a partially open position or a closed position, as desired. The CCU 368 may communicate with a vessel floating on the ocean surface 105 via the transceiver 380 and the at least one antenna 370. A ROV and/or a vessel floating on the ocean surface 105 may recharge the battery 382 and/or directly provide the necessary voltage and current, via an input jack 384, to power the processor 378 and the transceiver 380. Various communication techniques, such as very low frequency radio techniques coupled with digital signal processing and digitally modulated radio communications methods, may be implemented to facilitate communications via the antenna 370. Alternatively, various types of radio frequency (RF), optic and acoustic communication methods, as well as wired (umbilical) technologies, may be implemented for deep water communications between the vessel floating on the ocean surface 105 and the cylindrical BOPstopper containment assembly 300.

FIG. 4A shows a top view of a cylindrical BOPstopper valve assembly 400 that is configured in accordance with the first embodiment of the present invention. The cylindrical BOPstopper valve assembly 400 may have the same diameter as the cylindrical BOPstopper containment assembly 300 shown in FIGS. 3A and 3B. The cylindrical BOPstopper valve assembly 400 comprises at least one large diameter high pressure valve 402, at least one seal (e.g., an inner seal 404 and an outer seal 406) that is mounted along the entire bottom perimeter of the cylindrical BOPstopper valve assembly 400, as well as a plurality of reinforcement material input valves 410.

Preferably, the large diameter high pressure valve 402 and the reinforcement material input valves 410 may be configured to be remotely controlled (either wirelessly or via a wired or hydraulic connection from a vessel floating on the ocean surface 105) to maintain an open position, a partially open position or a closed position, as desired.

In its open position, the high pressure valve 402 is configured with an opening of such a large diameter that the spewing oil and/or gas 210 would pass through it without being sufficiently impeded by ice-like crystals (i.e., icy hydrates) that may form near the bottom of an ocean.

Still referring to FIG. 4A, the cylindrical BOPstopper valve assembly 400 further comprises a hollow cavity 412 that surrounds the large diameter high pressure valve 402. The hollow cavity 412 is configured to be filled with reinforcement material (e.g., cement and/or mud) via at least one of the reinforcement material input valves 410. The cylindrical BOPstopper valve assembly 400 may also comprise a pressure monitor unit 414 for monitoring the pressure of the oil and/or gas spill 210. The cylindrical BOPstopper valve assembly 400 may further comprise a CCU 416 and at least one antenna 418.

FIG. 4B shows a side view of the cylindrical BOPstopper valve assembly 400 of FIG. 4A. As shown in FIG. 4B, the hollow cavity 412 of the cylindrical BOPstopper valve assembly 400 comprises a floor 420, a ceiling 422 and a wall 424. The floor 420, ceiling 422 and wall 424 of the hollow cavity 412 of the cylindrical BOPstopper valve assembly 400 may be steel-reinforced, or consist of any other metal of a suitable strength and thickness. Optionally, the cylindrical BOPstopper valve assembly 400 may comprise a plurality of flooding valves 426, which may be located on the wall 424 and/or on the floor 420 of the hollow cavity 412. Preferably, the flooding valves 426 may be configured to be remotely controlled (either wirelessly or via a wired or hydraulic connection from a vessel floating on the ocean surface 105) to maintain an open position, a partially open position or a closed position, as desired.

The cylindrical BOPstopper valve assembly 400 may also comprise a plurality of hoist rings 428 that may be used during the submersion and positioning of the cylindrical BOPstopper valve assembly 400 by using a vessel floating on the ocean surface 105, and/or by using at least one ROV. In addition, the cylindrical BOPstopper valve assembly 400 comprises a pressure sensor 430, located near the floor 420 of the hollow cavity 412 just inside the entrance to the large diameter high pressure valve 402, that communicates with the pressure monitor unit 414, and optionally, with a vessel floating on the ocean surface 105, via a wired connection and/or a wireless communication link. Optionally, the cylindrical BOPstopper valve assembly 400 may further comprise one or more heating element(s) 432 for heating up the large diameter valve 402. Preferably, the heating element(s) 432 may be configured to be remotely activated (either wirelessly or via a wired or hydraulic connection from a vessel floating on the ocean surface 105).

FIG. 4C is a block diagram of the CCU 416 of the cylindrical BOPstopper valve assembly 400 of FIGS. 4A and 4B. As shown in FIG. 4C, the CCU 416 includes a processor 434, a transceiver 436, and a rechargeable battery/wired interface 438. The processor 434 is configured to control the reinforcement material input valves 410 and the flooding valves 426 of the cylindrical BOPstopper valve assembly 400, either wirelessly or via a wired interface, such that they may be maintained in an open position, a partially open position or a closed position, as desired. The processor 434 may also be configured to control the at least one heating element 432, either wirelessly or via a wired interface. The BOPstopper valve assembly CCU 416 may communicate with a vessel floating on the ocean surface 105 via the transceiver 436 and the at least one antenna 418. A ROV and/or a vessel floating on the ocean surface 105 may recharge the battery 438 and/or directly provide the necessary voltage and current, via an input jack 440, to power the processor 434 and the transceiver 436. Various communication techniques, such as very low frequency radio techniques coupled with digital signal processing and digitally modulated radio communications methods, may be implemented to facilitate communications via the antenna 418. Alternatively, various types of radio frequency (RF), optic and acoustic communication methods, as well as wired (umbilical) technologies, may be implemented for deep water communications between the vessel floating on the ocean surface 105 and the cylindrical BOPstopper valve assembly 400.

Although a cylindrical geometry has been proposed for the BOPstopper valve assembly 400 to minimize leakage of the spewing oil and/or gas 210 at joints (i.e., corners) of a containment system, any other geometric configuration may be used. For example, FIG. 4D shows a top view of a square cuboid BOPstopper valve assembly 450 that is configured in accordance with the first embodiment of the present invention, and FIG. 4E shows a side view of the square cuboid BOPstopper valve assembly 450 of FIG. 4D.

As shown in FIG. 4D, the square cuboid BOPstopper valve assembly 450 comprises at least one large diameter high pressure valve 452, at least one seal (e.g., an inner seal 454 and an outer seal 456) that is mounted along the entire bottom perimeter of the square cuboid BOPstopper valve assembly 450, as well as a plurality of reinforcement material input valves 460. The square cuboid BOPstopper valve assembly 450 further comprises a hollow cavity 462 that surrounds the large diameter high pressure valve 452. The hollow cavity 462 is configured to be filled with reinforcement material (e.g., cement and/or mud) via at least one of the reinforcement material input valves 460. The square cuboid BOPstopper valve assembly 450 also comprises a pressure monitor unit 464 for monitoring the pressure of the oil and/or gas spill 210. The square cuboid BOPstopper containment assembly 450 further comprises a CCU 466 and at least one antenna 468.

As shown in FIG. 4E, the hollow cavity 462 of the square cuboid BOPstopper valve assembly 450 comprises a floor 470, a ceiling 472 and a wall 474. Optionally, the square cuboid BOPstopper valve assembly 450 may comprise a plurality of flooding valves 476, which may be located on the wall 474 and/or on the floor 470 of the hollow cavity 462. The square cuboid BOPstopper valve assembly 450 may also comprise a plurality of hoist rings 478 that may be used during the submersion and positioning of the square cuboid BOPstopper valve assembly 450 by using a vessel floating on the ocean surface 105, and/or by using at least one ROV. In addition, the square cuboid BOPstopper valve assembly 450 comprises a pressure sensor 480, located near the floor 470 of the hollow cavity 462 just inside the entrance to the large diameter high pressure valve 402, that communicates with the pressure monitor unit 464, and optionally, with a vessel floating on the ocean surface 105, via a wired connection and/or a wireless communication link. Optionally, the square cuboid BOPstopper valve assembly 400 may further comprise one or more heating element(s) 482 for heating up the large diameter valve 452. Preferably, the heating element(s) 482 may be configured to be remotely activated (either wirelessly or via a wired or hydraulic connection from a vessel floating on the ocean surface 105).

FIG. 4F is a block diagram of the CCU 466 of the square cuboid BOPstopper valve assembly 450 of FIGS. 4D and 4E. As shown in FIG. 4F, the CCU 466 includes a processor 484, a transceiver 486, and a rechargeable battery/wired interface 488. The processor 484 is configured to control the reinforcement material input valves 460 and the flooding valves 476 of the square cuboid BOPstopper valve assembly 450, either wirelessly or via a wired interface, such that they may be maintained in an open position, a partially open position or a closed position, as desired. The processor 484 may also be configured to control the at least one heating element 482, either wirelessly or via a wired interface. The CCU 466 may communicate with a vessel floating on the ocean surface 105 via the transceiver 486 and the at least one antenna 488. A ROV and/or a vessel floating on the ocean surface 105 may recharge the battery 488 and/or directly provide the necessary voltage and current, via an input jack 490, to power the processor 484 and the transceiver 486. Various communication techniques, such as very low frequency radio techniques coupled with digital signal processing and digitally modulated radio communications methods, may be implemented to facilitate communications via the antenna 468. Alternatively, various types of radio frequency (RF), optic and acoustic communication methods, as well as wired (umbilical) technologies, may be implemented for deep water communications between the vessel floating on the ocean surface 105 and the cylindrical BOPstopper valve assembly 400.

FIG. 5 shows a cross-sectional view of the cylindrical BOPstopper valve assembly 400 of FIGS. 4A and 4B positioned on top of the cylindrical BOPstopper containment assembly 300 after it is reinforced (hereinafter referred to as the reinforced cylindrical BOPstopper containment assembly 300′). As shown in FIG. 5, the at least one large diameter high pressure valve 402 protrudes through the ceiling 422 of the hollow cavity 412.

When the cylindrical BOPstopper valve assembly 400 is submerged below the ocean surface 105 and is positioned on top of the reinforced cylindrical BOPstopper containment assembly 300′, the large diameter high pressure valve 402 is maintained in a fully open position such that the oil and/or gas 210 spewing from the defective BOP stack 120′ is allowed to pass through the large diameter high pressure valve 402. By leaving at least one high pressure valve 402 of a suitable diameter in a fully open position, buoyancy problems due to the pressure of the spewing oil and/or gas 210 may be minimized, while the hollow cavity 412 of the cylindrical BOPstopper valve assembly 400, surrounding the large diameter high pressure valve 402, is filled with reinforcement material (e.g., cement and/or mud).

FIG. 6 shows a cross-sectional view of the hollow cavity 412 of the cylindrical BOPstopper valve assembly 400 being filled with reinforcement material (e.g., cement and/or mud).

FIG. 7 shows a cross-sectional view of the cylindrical BOPstopper valve assembly 400 after it has been filled with the reinforcement material (hereinafter referred to as the reinforced BOPstopper cylindrical valve assembly 400′), and its large diameter high pressure valve 402 has been closed, resting on top of the reinforced cylindrical BOPstopper containment assembly 300′.

FIGS. 8A and 8B show a side view of the reinforced cylindrical BOPstopper valve assembly 400′ positioned on top of the reinforced cylindrical BOPstopper containment assembly 300′.

FIG. 9A and 9B show a side view of a reinforced square cuboid BOPstopper valve assembly 450′ positioned on top of the reinforced square cuboid BOPstopper containment assembly 350′.

A riser assembly 125 may be attached between the large diameter high pressure valve 402/452 and a containment vessel floating on the ocean surface 105. The large diameter high pressure valve 402/452 may then be opened to allow the oil and/or gas 210 to be stored by the containment vessel.

The pressure of the oil and/or gas 210 may be monitored by the pressure monitor unit 414/464 after the large diameter high pressure valve 402/452 is closed. The large diameter high pressure valve 402/452 may be automatically opened by the pressure monitor unit 414/464 when the pressure sensor 430/480 detects a pressure within the reinforced BOPstopper containment assembly 300′/400′ that reaches or exceeds a predetermined threshold.

The hollow wall 302/352 of the reinforced BOPstopper containment assembly 300′/350′ may be of such a large width (e.g., 10 feet or more), that it may be unlikely that the reinforced BOPstopper containment assembly 300′/350′ would sink very far below the ocean floor 115, and thus the mud flaps 316/366 may not be necessary. However, the extreme weight applied to the top perimeter of the hollow wall 302/352 of the reinforced BOPstopper containment assembly 300′/350′ may be so great, that the reinforced BOPstopper containment assembly 300′/350′ may sink many feet below the ocean floor 115. Thus, it is important to perform initial tests and analysis in a laboratory setting to determine more precise and optimal dimensions that may be applicable to a particular BOP stack failure situation.

FIGS. 10A and 10B, taken together, are a flow diagram of a procedure 1000 for containing oil and/or gas spewing from a defective BOP stack 120′ using a BOPstopper containment assembly 300′/350′ and a BOPstopper cylindrical valve assembly 400′/450′ in accordance with the first embodiment of the present invention.

In step 1005 of the procedure 1000 of FIG. 10A, a BOPstopper containment assembly 300/350, having a hollow wall 302/352 with a reinforcement cavity 304/354, is submerged below the ocean surface 105 by opening at least one of a first plurality of flooding valves 324/374 on the BOPstopper containment assembly 300/350 to fill the reinforcement cavity 304/354 with water from the ocean. In step 1010, the BOPstopper containment assembly 300/350 is positioned on a portion of an ocean floor 115 that circumvents a defective BOP stack 120′. In step 1015, the at least one of the first plurality of flooding valves 324/374 on the BOPstopper containment assembly 300/350 is closed. In step 1020, reinforcement material (e.g., cement and/or mud) is pumped into at least one of a first plurality of reinforcement material input valves 310/360 of the BOPstopper containment assembly 300/350 until the reinforcement cavity 304/354 of the hollow wall 302/352 of the BOPstopper containment assembly 300/350 is filled with the reinforcement material. In step 1025, a BOPstopper valve assembly 400/450, having a hollow cavity 412/462 that surrounds at least one large diameter high pressure valve 402/452, is submerged below the ocean surface 105 by opening at least one of a second plurality of flooding valves 426/476 on the BOPstopper valve assembly 400/450 to fill the hollow cavity 412/462 with water from the ocean.

In step 1030 of the procedure 1000 of FIG. 4B, the BOPstopper valve assembly 400/450 is positioned on top of the reinforced BOPstopper containment assembly 300′/350′ such that at least one first seal 404/406/454/456, mounted along the entire bottom perimeter of the BOPstopper valve assembly 400/450, mates with at least one second seal 312/314/362/364 mounted along the entire top perimeter of the reinforced BOPstopper containment assembly 300′/350′, and the oil and/or gas 210 spewing from the defective BOP stack 120′ is allowed to pass through the large diameter high pressure valve 402/452, which is maintained in an open position. In step 1035, the at least one of the second plurality of flooding valves 426/476 on the BOPstopper valve assembly 400/450 is closed. In step 1040, reinforcement material (e.g., cement and/or mud) is pumped into at least one of a second plurality of reinforcement material input valves 410/460 on the BOPstopper valve assembly 400/450 until the hollow cavity 412/462 of the BOPstopper valve assembly 400/450 is filled with the reinforcement material, causing the first seal 404/406/454/456 and the second seal 312/314/362/364 to compress together. In step 1045, the large diameter high pressure valve 402/452 of the reinforced BOPstopper valve assembly 400′/450′ is slowly closed, while using the pressure monitor unit 414/464 to monitor the pressure within the reinforced BOPstopper containment assembly 300′/350′, until the oil and/or gas 210 stops flowing through the large diameter high pressure valve 402/452.

As an example, the diameter/width of the BOPstopper containment assembly 300/350 may be on the order of 80 feet, and the height of the BOPstopper containment assembly 300/350 may be on the order of 60 feet. The width of the hollow wall 302/352 of the BOPstopper containment assembly 300/350 may be on the order of 10 feet. The diameter/width of the BOPstopper valve assembly 400/450 may be the same as the diameter/width of the BOPstopper containment assembly 300/350, and the height of the BOPstopper valve assembly 400/450 may be on the order of 80 feet. Thus, the hollow cavity 412 of the of the cylindrical BOPstopper valve assembly 400 may be able to hold on the order of 400,000 cubic feet of reinforcement material (e.g., cement and/or mud), whereas the hollow cavity 462 of the square cuboid BOPstopper valve assembly 450 may be able to hold on the order of 510,000 cubic feet of reinforcement material.

For example, depending upon the type of reinforcement material used, which may range from 90 to 140 pounds per cubic foot, and how much is poured into the hollow cavity 412 of the cylindrical BOPstopper valve assembly 400, the weight applied to the top perimeter of the reinforced cylindrical BOPstopper containment assembly 300′ to counter the pressure of the spewing oil and/or gas 210 may be on the order of 25,000 tons. The enormous mass of the reinforced cylindrical valve assembly 400′, combined with the large mass of the cement-filled reinforcement cavity 304 of the reinforced cylindrical containment assembly 300′, should insure that the oil and/or gas 210 would not be able to pass through the bottom of the reinforced cylindrical containment assembly 300′, since the annular rim 322 would be applying a huge force to the ocean floor 115, causing it to compress and form an watertight seal with the bottom of the reinforced cylindrical containment assembly 300′.

The diameter of the valve 402/452 is critical to the first embodiment of the present invention, and may be on the order of six feet. For example, the diameter of the valve 402/452 may be similar to the diameter of jet flow gates used for dams, such as the Hoover Dam, which may range in diameter from 68 to 90 inches. The valve 402/452 is designed to operate under high pressure (e.g., 10,000-15,000 pounds per square inch (PSI)), and may include a steel plate that may be opened or closed to either prevent or allow the spewing oil and/or gas 210 to be discharged.

As would be known by one of ordinary skill, smaller or larger dimensions may be applicable to the components used to implement the various embodiments of the BOPstopper in accordance with the particular BOP failure situation that the assemblies 300, 350, 400 and 450 are designed for. For example, initial tests and analysis should be performed in a laboratory setting to determine more precise dimensions that may be applicable to a particular BOP stack failure situation.

The first embodiment of the present invention, as described above in conjunction with FIGS. 3A-3I, 4A-4F, 5-7, 8A, 8B, 9A, 9B, 10A and 10B, may incorporate any of the features of the additional embodiments described below. For example, it may be desired to add top kill input valves to allow top kill cement and/or mud to flow within the inner wall 306 of the cylindrical BOPstopper containment assembly 300, or to fasten a secondary containment assembly between the large diameter high pressure valve 402 of the cylindrical BOPstopper valve assembly 400 and at least one containment vessel floating on the ocean surface 105 to store the oil and/or gas 210.

FIG. 11A shows a primary containment assembly 1100 configured to circumvent a defective BOP stack 120′ in accordance with a second embodiment of the present invention. The primary containment assembly 1100 may be configured in a cylindrical or conical shape, but must be large enough to sufficiently circumvent the defective BOP stack 120′. The primary containment 1100 may comprise a first opening 1105 that circumvents the defective BOP stack 120′. The first opening 1105 is preferably configured to be fastened and sealed to the ocean floor 115 by using, for example, a self-fastening mechanism 1110 comprising fastening devices 1115 and/or sealing devices 1120.

Still referring to FIG. 11A, the primary containment assembly 1100 may further comprise a second opening 1125 that is narrower than the first opening 1105 and through which the spewing oil and/or gas 210 may rise to a secondary containment assembly (e.g., see FIGS. 13A, 13B and 13C).

FIG. 11B shows a top view of the primary containment assembly 1100 of FIG. 11A including the second opening 1125.

FIG. 11C shows a bottom view of the self-fastening mechanism 1110 of the primary containment assembly 1100 of FIG. 11A including activated fastening elements 1130 projecting from the fastening devices 1115, and sealant 1135 released from the sealing devices 1120. The self-fastening mechanism 1110 may include a series of small explosive charges that, when detonated, force the fastening elements 1130 to project from the fastening devices 1115, and fasten the primary containment assembly 1100 to the ocean floor 115. The self-fastening mechanism 1110 may be activated to release sealant 1135 that provides a water-tight seal between the primary containment assembly 1100 and the ocean floor 115.

FIG. 11D shows a side view of the primary containment assembly 1100 of FIG. 11A circumventing the defective BOP stack 120′ and fastened to the ocean floor 115 via the fastening elements 1130 of the self-fastening mechanism 1110.

FIG. 12A shows a primary containment assembly 1200 configured to circumvent a defective BOP stack 120′ in accordance with an alternative to the second embodiment of the present invention. The primary containment assembly 1200 may be configured in a cylindrical or conical shape, but must be large enough to sufficiently circumvent the defective BOP stack 120′. The primary containment 1200 may comprise a first opening 1205 that circumvents the defective BOP stack 120′. The first opening 1205 is preferably configured to be fastened and sealed to the ocean floor 115 by using, for example, a self-fastening mechanism 1210 that rotates at least one blade 1215 used to burrow a portion of the primary containment assembly 1200 below the ocean floor 115.

Still referring to FIG. 12A, the primary containment assembly 1200 may further comprise a second opening 1220 that is narrower than the first opening 1205 and through which the spewing oil and/or gas 210 may rise to a secondary containment assembly (e.g., see FIGS. 13A, 13B and 13C).

FIG. 12B shows a top view of the primary containment assembly 1200 of FIG. 12A including the second opening 1220.

FIG. 12C shows a bottom view of the self-fastening mechanism 1210 of the primary containment assembly 1200 of FIG. 12A including at least one rotating blade 1215 of the self-fastening mechanism 1210.

FIG. 12D shows a side view of the primary containment assembly 550 of FIG. 12A circumventing the defective BOP stack 120′ and fastened to the ocean floor 115 via the blade(s) 1215 of the self-fastening mechanism 1210.

The primary containment assembly 1100/1200 is lowered below the ocean surface 105 and positioned on a portion of the ocean floor 115 that circumvents the defective BOP stack 120′. Although it may be possible to lower the primary containment assembly 1100/1200 over the defective BOP stack 120′ if the riser assembly 125 remains in a vertical position by letting the riser assembly 125 pass through the first opening 1105/1205 and the second opening 1125/1220 of the primary containment assembly 1100/1200, the riser assembly 125 needs to be disconnected (i.e., cut off) near the top of the defective BOP stack 120′ if a catastrophic event caused the riser assembly 125 to collapse (i.e., fold over), as what occurred due to the Deepwater Horizon drilling rig explosion.

Preferably, it would be desirable to grade the portion of the ocean floor 115 that circumvents the defective BOP stack 120′ before the primary containment assembly 1100/1200 is positioned, in order to optimize the reduction of the pollution of the ocean caused by the oil and/or gas 210 spewing from the defective BOP stack 120′. Such ocean floor grading may be performed by at least one ROV.

Furthermore, the ROV may be used to assist in the lowering and positioning of the primary containment assembly 1100/1200.

Alternatively, the primary containment assembly 1100/1200 may consist of a plurality of sections and/or components that may be constructed and stored onshore close to areas where deepwater rigs are active. The sections and/or components may include seals and/or gaskets, and may be assembled together as they are submerged just under the ocean surface 105.

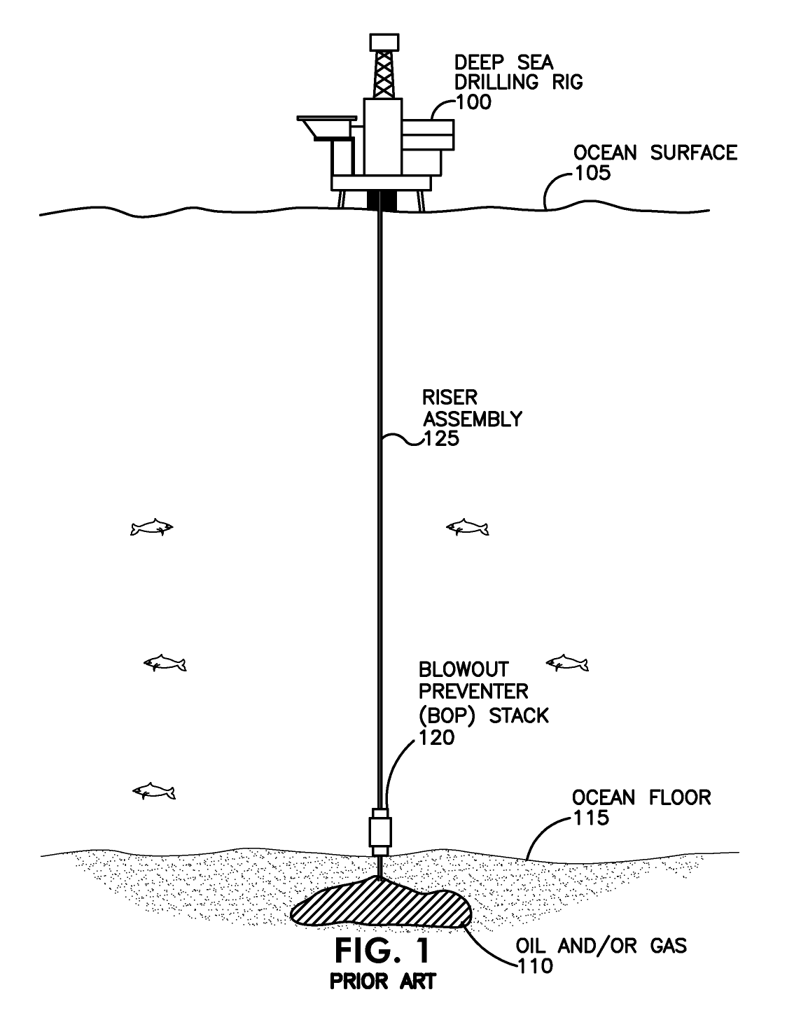

FIG. 13A shows a secondary containment assembly 1310 configured to be fastened between the primary containment assembly 1100/1200 at the second opening 1125/1220 and at least one containment vessel floating on the ocean surface 105 in accordance with the second embodiment of the present invention. The secondary containment assembly 1310 may be similar to a riser assembly 125 that is typically connected directly to a properly operating BOP stack 120, as shown in FIG. 1, but instead of being attached to the BOP stack 120, a first opening 1315 of the secondary containment assembly 1310 is directly attached to the second opening 1125/1220 of the primary containment assembly 1100/1200, and a second opening 1320 of the secondary containment assembly 1310 is either directly or indirectly attached to at least one containment vessel floating on the ocean surface 105 to allow the spewing oil and/or gas 210 to rise from the second opening 1125/1220 of the primary containment assembly 1100/1200 to the containment vessel. The secondary containment assembly 1310 is preferably configured in a cylindrical shape, but must be long enough to reach the ocean surface 105.

FIG. 13B shows a secondary containment assembly 1330 configured to be fastened between the primary containment assembly 1100/1200 at the second opening 1125/1220 and at least one containment vessel floating. The secondary containment assembly 1330 comprises a plurality of sections 1335 that are interconnected to allow the spewing oil and/or gas 210 to rise from the second opening 1125/1220 of the primary containment assembly 1100/1200 to at least one containment vessel floating on the ocean surface 105. The sections 1325 may be identical, or have varying lengths, but are all preferably configured in a cylindrical shape that, after being interconnected, are long enough to reach the ocean surface 105.

FIG. 13C shows a secondary containment assembly 1350 configured to be fastened between the primary containment assembly 1100/1200 at the second opening 1125/1220 and at least one containment vessel floating on the ocean surface 105. The secondary containment assembly 1350 may comprise a flexible ducting hose, or a plurality of flexible ducting hose sections that are connected in a similar fashion as the sections 1335 of the secondary containment assembly 1330 of FIG. 13B.

FIG. 14A shows a side view of the assembled first and second containment assemblies 1100/1200/1310/1330/1350 connected between the ocean floor 115 and a containment vessel 1410.

FIG. 14B shows a side view of the assembled first and second containment assemblies 1100/1200/1310/1330/1350 connected between the ocean floor 115 and an oil and/or gas routing device 1420 that is controlled to allow the oil and/or gas to be routed via one or more flexible containment sections (i.e., sections of flexible ducting hose) 1430A, 1430B and 1430C in order to be stored by one or more respective containment vessels 1440A, 1440B and 1440C. By using the flexible containment sections 1430A, 1430B and 1430C, the containment vessels are free to move relative to the routing device 1420 due to the influence of tides, currents and weather. Oil would either be pumped to the containment vessels or rise naturally from the routing device due to its own buoyancy.

FIG. 15 is a flow diagram of a procedure 1500 for containing oil and/or gas spewing from a defective BOP stack 120′ located on an ocean floor 115 and causing pollution to the ocean. In step 1505, a primary containment assembly 1100/1200 is lowered below the ocean surface 105. In step 1510, the primary containment assembly 1100/1200 is positioned on a portion of the ocean floor 115 that circumvents the defective BOP stack 120′. In step 1515, the primary containment assembly 1100/1200 is fastened to the ocean floor 115. In step 1520, a secondary containment assembly 1310/1330/1350 is lowered below the ocean surface 105. In step 1525, the secondary containment assembly 1310/1330/1350 is fastened between the primary containment assembly 1100/1200 and at least one containment vessel 1410/1440 on the ocean surface 105. One or more of steps 1505, 1510, 1515, 1520 and 1525 may be performed by at least one ROV. In step 1530, the oil and/or gas 210 spewing from the defective BOP stack 120′ is stored in the at least one containment vessel 1410/1440.

FIG. 16 shows a side view of a primary containment assembly 1100′ or 1200′ configured to receive top kill cement and/or mud 1605/1610 from vessels 1615 via a first set of top kill input valves 1620, while regulating the output of the leaking oil and/or gas being contained by a containment vessel 1625 via a large diameter high pressure valve 1630 mounted on an upper opening of the primary containment assembly 1100′ or 1200′ in accordance with a third embodiment of the present invention. Thus, the entire defective BOP stack 120′ is submerged in the cement and/or mud 1605/1610, which is contained within the walls of the primary containment assembly 1100′ or 1200′. Assuming that the primary containment assembly 1100′ or 1200′ is of sufficient size and thickness, as could be determined in a laboratory setting, the underground well for which the defective BOP stack 120′ was designed to control, should stop spewing the oil and/or gas 210 due to being completely surrounded in a deep layer of the cement and/or mud 1605/1610 that is sufficiently contained. Preferably, the large diameter high pressure valve 1630 may be configured to be remotely controlled (either wirelessly or via a wired or hydraulic connection from a vessel floating on the ocean surface 105) to maintain an open position, a partially open position or a closed position, as desired.

In accordance with a fourth embodiment of the present invention, FIG. 17 shows a side view of a primary containment assembly 1700 having a hollow steel-reinforced wall 1705 configured to contain reinforcement material (e.g., cement and/or mud) received via a set of wall reinforcement input valves 1710, and a hollow cavity 1715 configured to contain reinforcement material (e.g., top kill cement and/or mud) received via a second set of top kill input valves 1720 configured to receive top kill cement and/or mud to fill a bottom portion of the primary containment assembly 1700, while regulating the output of the spewing oil and/or gas 210 via a large diameter high pressure valve 1725 mounted on an upper opening of the primary containment assembly 1700 that, optionally, may be heated by one or more heating elements 1730. Preferably, the large diameter high pressure valve 1725 may be configured to be remotely controlled (either wirelessly or via a wired or hydraulic connection from a vessel floating on the ocean surface 105) to maintain an open position, a partially open position or a closed position, as desired.

FIG. 18 is a flow diagram of a procedure 1800 for containing oil and/or gas 210 spewing from a defective BOP stack 120′ using the primary containment assembly 1700 of FIG. 17. In step 1805, the primary containment assembly 1700 is lowered below the ocean surface 105 with the large diameter high pressure valve 1725 maintained in an open position. In step 1810, the heating element(s) 1730 is activated to reduce/eliminate buoyancy problems that may be caused by the spewing oil and/or gas 210. Furthermore, in its open position, the large diameter high pressure valve 1725 is configured with an opening of such a large diameter that the oil and/or gas 210 would pass through it without being sufficiently impeded by ice-like crystals (i.e., icy hydrates) that may form near the bottom of an ocean. However, the heating element(s) 1730 is used to insure that this is the case. In step 1815, the primary containment assembly 1700 is positioned on a portion of the ocean floor 115 that circumvents a defective BOP stack 120′. As previously described, the primary containment assembly 1700 has a hollow steel-reinforced wall 1705. In step 1720, the hollow steel-reinforced wall 1705 of the primary containment assembly 1700 is filled with reinforcement material (e.g., cement and/or mud) via wall reinforcement input valves 1710. In step 1825, a hollow inner cavity 1715 of the primary containment assembly 1700, in which the defective BOP stack 120′ resides, is filled with reinforcement material (e.g., top kill cement and/or mud) via a second set of top kill input valves 1720. Finally, in step 1830, the upper opening of the primary containment assembly 1700 is filled with top kill cement and/or mud, and the large diameter high pressure valve 1725 is then closed.

What is claimed is:

1. A method of controlling valves of a subsea oil spill containment assembly, the method comprising:
controlling at least one valve of the subsea oil spill containment assembly such that the valve is maintained in an open position, a partially open position or a closed position.

2. The method of claim 1 wherein the valve is a reinforcement material input valve that is used to fill a reinforcement cavity of the subsea oil spill containment assembly with reinforcement material including at least one of cement and mud, the reinforcement cavity residing between an inner wall and an outer wall of the containment assembly.

3. The method of claim 1 wherein the valve is remotely controlled either wirelessly or via a wired or hydraulic connection from a vessel floating on an ocean surface.

4. The method of claim 1 wherein the valve is a reinforcement material input valve that is used to fill a hollow cavity of the subsea oil spill containment assembly with reinforcement material including at least one of cement and mud, the hollow cavity surrounding a large diameter high pressure valve.

5. The method of claim 1 wherein the valve is a flooding valve used to fill a reinforcement cavity of the subsea oil spill containment assembly with water from an ocean to submerge the containment assembly below the ocean surface, the reinforcement cavity residing between an inner wall and an outer wall of the containment assembly.

6. The method of claim 1 wherein the valve is a flooding valve used to fill a hollow cavity of the subsea oil spill containment assembly with water from an ocean to submerge the containment assembly below the ocean surface, the hollow cavity surrounding a large diameter high pressure valve.

7. The method of claim 1 wherein the valve is a large diameter high pressure valve used to control the flow of at least one of oil or gas spewing from a defective blowout preventer (BOP) stack.

8. The method of claim 7 further comprising:
activating at least one heating element to heat up the large diameter high pressure valve.

9. The method of claim 8 wherein the heating element is remotely controlled either wirelessly or via a wired or hydraulic connection from a vessel floating on an ocean surface.

10. The method of claim 7 further comprising:
automatically opening the large diameter high pressure valve when a pressure within the subsea oil spill containment assembly reaches or exceeds a predetermined threshold.

11. A control unit for controlling valves of a subsea oil spill containment assembly, the control unit comprising:
at least one of a battery or wired interface; and
a processor connected to the battery or wired interface, wherein the processor is configured to control at least one valve of the subsea oil spill containment assembly such that the valve is maintained in an open position, a partially open position or a closed position.

12. The control unit of claim 11 wherein the valve is a reinforcement material input valve that is used to fill a reinforcement cavity of the subsea oil spill containment assembly with reinforcement material including at least one of cement and mud, the reinforcement cavity residing between an inner wall and an outer wall of the containment assembly.

13. The control unit of claim 11 wherein the valve is remotely controlled either wirelessly or via a wired or hydraulic connection from a vessel floating on an ocean surface.

14. The control unit of claim 11 wherein the valve is a reinforcement material input valve that is used to fill a hollow cavity of the subsea oil spill containment assembly with reinforcement material including at least one of cement and mud, the hollow cavity surrounding a large diameter high pressure valve.

15. The control unit of claim 11 wherein the valve is a flooding valve used to fill a reinforcement cavity of the subsea oil spill containment assembly with water from an ocean to submerge the containment assembly below the ocean surface, the reinforcement cavity residing between an inner wall and an outer wall of the containment assembly.

16. The control unit of claim 11 wherein the valve is a flooding valve used to fill a hollow cavity of the subsea oil spill containment assembly with water from an ocean to submerge the containment assembly below the ocean surface, the hollow cavity surrounding a large diameter high pressure valve.

17. The control unit of claim 11 wherein the valve is a large diameter high pressure valve used to control the flow of at least one of oil or gas spewing from a defective blowout preventer (BOP) stack.

18. The control unit of claim 17 wherein the processor is further configured to activate at least one heating element of the subsea oil spill containment assembly to heat up the large diameter high pressure valve.

19. The control unit of claim 18 wherein the heating element is remotely controlled either wirelessly or via a wired or hydraulic connection from a vessel floating on an ocean surface.

20. The control unit of claim 17 wherein the processor is configured to automatically open the large diameter high pressure valve when a pressure within the subsea oil spill containment assembly reaches or exceeds a predetermined threshold.
